(19) United States
(12) Patent Application Publication
(10) Pub. No.: US 2013/0140372 A1
(43) Pub. Date: Jun. 6, 2013

(54) TEMPERATURE CONTROL OF A MOVER WITH ACTIVE BYPASS, PREDICTIVE FEEDFORWARD CONTROL, AND PHASE CHANGE HOUSING

(71) Applicant: NIKON CORPORATION, Tokyo (JP)

(72) Inventors: Chetan MAHADESWARASWAMY, San Francisco, CA (US); Michel PHARAND, Los Gatos, CA (US); Michael B. BINNARD, Belmont, CA (US)

(73) Assignee: NIKON CORPORATION, Tokyo (JP)

(21) Appl. No.: 13/756,176

(22) Filed: Jan. 31, 2013

Related U.S. Application Data
(63) Continuation-in-part of application No. 13/538,421, filed on Jun. 29, 2012.
(60) Provisional application No. 61/503,095, filed on Jun. 30, 2011.
(60) Provisional application No. 61/592,712, filed on Jan. 31, 2012.
(60) Provisional application No. 61/594,250, filed on Feb. 2, 2012.
(60) Provisional application No. 61/594,273, filed on Feb. 2, 2012.

(51) Int. Cl. F27D 3/00

(52) U.S. Cl. CPC F27D 3/00
USPC 236/12.1

(57) ABSTRACT

A stage assembly includes (i) a stage; (ii) a base assembly; (iii) a stage mover, and (iv) a temperature controller. The stage mover includes a magnet array and a conductor array. The conductor array can be grouped into one or more zones. The temperature controller selectively directs a circulation fluid at a first temperature, and at a second temperature to each zone. Feedforward signals based on the expected heat dissipation of the conductor array can be used to improve the response time of the temperature controller. The temperature controller can include a phase change material and a housing assembly that retains the phase change material in an enclosed chamber near the conductor array.

### RELATED INVENTION

This application claims priority on U.S. Provisional Application Ser. No. 61/592,712, filed Jan. 31, 2012, and entitled “SYSTEM AND METHOD FOR CONTROLLING A SURFACE TEMPERATURE OF A CONDUCTION ARRAY”. This application also claims priority on U.S. Provisional Application Ser. No. 61/594,250, filed Feb. 2, 2012, and entitled “TEMPERATURE CONTROL OF A MOVER WITH ACTIVE BYPASS AND PREDICTIVE FEEDFORWARD CONTROL”. Further, this application claims priority on U.S. Provisional Application Ser. No. 61/594,273, filed Feb. 2, 2012, and entitled “SYSTEM AND METHOD FOR CONTROLLING A TEMPERATURE OF A CONDUCTOR ARRAY”. As far as permitted, the contents of U.S. Provisional Application Ser. Nos. 61/592,712, 61/594,250, and 61/594,273 are incorporated herein by reference.

This application is a continuation in part of U.S. patent application Ser. No. 13/538,421 filed on Jun. 29, 2012 and entitled “HYBRID COOLING AND THERMAL SHIELD FOR ELECTROMAGNETIC ACTUATORS”. U.S. patent application Ser. No. 13/538,421 claims priority on U.S. Provisional Application Ser. No. 61/503,095, filed Jun. 30, 2011, and entitled “HYBRID COOLING AND THERMAL SHIELD FOR ELECTROMAGNETIC ACTUATORS”. As far as permitted, the contents of U.S. application Ser. No. 13/538,421 and U.S. Provisional Application Ser. No. 61/503,095 are incorporated herein by reference.

### BACKGROUND

Exposure apparatuses are commonly used to transfer images from a reticle onto a semiconductor wafer during semiconductor processing. A typical exposure apparatus includes an illumination source, a reticle stage assembly that retains a reticle, a lens assembly and a wafer stage assembly that retains a semiconductor wafer.

Typically, the wafer stage assembly includes a wafer stage base, a wafer stage that retains the wafer, and a wafer stage mover assembly that precisely positions the wafer stage and the wafer. Somewhat similarly, the reticle stage assembly includes a reticle stage base, a reticle stage that retains the reticle, and a reticle stage mover assembly that precisely positions the reticle stage and the reticle. The size of the images and the features within the images transferred onto the wafer from the reticle are extremely small. Accordingly, the precise relative positioning of the wafer and the reticle is critical to the manufacturing of high density, semiconductor wafers.

Unfortunately, the stage mover assemblies generate heat that can influence the other components of the exposure apparatus. Conventionally, the stage mover assemblies are cooled by forcing a coolant around the movers of the stage mover assembly. However, existing coolant systems are not entirely satisfactory. This reduces the accuracy of positioning of the wafer relative to the reticle, and degrades the accuracy of the exposure apparatus.

### SUMMARY

The present invention is directed to a stage assembly that moves a device. In one embodiment, the stage assembly includes a stage that retains the device, a base assembly, a stage mover, a temperature controller, and a control system. The stage mover moves the stage. The stage mover includes a magnet array that is secured to one of the stage and the base assembly, and a conductor array that is secured to the other of the stage and the base assembly. In one embodiment, the conductor array includes a first zone having a first heat exchanger and a second zone having a second heat exchanger. Further, the temperature controller includes (i) an inlet valve assembly that is in fluid communication with the first heat exchanger, and the second heat exchanger, and (ii) a first temperature system that is in fluid communication with the inlet valve assembly, the first temperature system simultaneously directing a body circulation fluid at a first temperature, and at a second temperature the inlet valve assembly.

In one embodiment, the control system controls the inlet valve assembly to selectively control (i) the flow rate of the body circulation fluid at the first temperature, and the flow rate of the body circulation fluid at the second temperature that is directed to the first heat exchanger, and (ii) the flow rate of the body circulation fluid at the first temperature, and the flow rate of the body circulation fluid at the second temperature that is directed to the second heat exchanger.

In certain embodiments, the stage(s) for Lithography tools will be accelerated and decelerated using planar motors. These motors typically generate large amounts of heat due to resistive losses in the conductor array of the planar motor. However, an outer surface is required to be at a specified temperature within a tight band in order to avoid uneven heating of air which may cause position measurement errors due to varying refractive index at different locations. The present invention provides an efficient way to achieve the desired temperature control. With this design, the stage assembly can be used in an exposure apparatus to manufacture high density, high quality semiconductor wafers.

In one embodiment, each zone includes one or more feedback elements that provides feedback regarding the temperature of at least a portion of one of the zones, and the feedback is used by a control system to control the temperature controller. Additionally, the control system can utilize feedforward control to reduce overshoot and undershoot.

In another embodiment, the temperature controller includes a phase change material and a housing assembly that retains the phase change material in an enclosed chamber near the conductor array. The housing assembly can form an exposed surface of the conductor array that is adjacent to the magnet array. In another embodiment, the conductor array includes a plurality of conductor units, and the conductor array includes a separate housing assembly positioned near each conductor unit. In this embodiment, each housing assembly encloses a separate, enclosed phase change material.

In one embodiment, the stage mover is a planar motor and the conductor array includes a plurality of conductor units that are arranged in a rectangular shaped grid. Alternatively, the stage mover can be another type of motor, such as a linear motor, a rotary motor, a voice coil motor, or another type of actuator.

The present invention is also directed to an assembly for maintaining an area that retains a component at a substantially constant, predetermined temperature. The assembly can include (i) an enclosed housing that defines a first enclosure that is at the predetermined temperature, and a second enclosure that encircles the first enclosure, the first enclosure defining an area that retains the component; and (ii) a phase change material positioned in the second enclosure.

The present invention is also directed to an exposure apparatus, a device manufactured with the exposure apparatus, and/or a wafer on which an image has been formed by the exposure apparatus. Further, the present invention is also directed to a method for making a stage assembly, a method for making an exposure apparatus, a method for making a device, and a method for manufacturing a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a stage assembly having features of the present invention;

FIG. 2A is a cut-away view taken on line 2A-2A of FIG. 1;

FIG. 2B is an exploded perspective view of a portion of the conductor array and a base assembly of FIG. 1;

FIG. 2C is a bottom view of a stage and a magnet array having features of the present invention;

FIGS. 2D, 2E and 2F are alternative, top plan views of the conductor array, the base assembly, the temperature adjuster, and the control system;

FIG. 3 is a simplified schematic of a portion of the temperature adjuster;

FIG. 4A is a simplified schematic of a control system having features of the present invention;

FIG. 4B is a simplified schematic of an estimator having features of the present invention;

FIG. 5 is a simplified graph that illustrates power directed to a zone, a first temperature profile without feedforward control, and a second temperature profile with feedforward control;

FIG. 6A is a perspective view of another embodiment of a mover having features of the present invention;

FIG. 6B is a cut-away taken on line 6B-6B in FIG. 6A;

FIG. 7A is a top plan view of another embodiment of a conductor array, a base assembly, the temperature controller, and the control system;

FIG. 7B is a perspective view of a portion of the base assembly, the temperature controller, an exploded perspective view of a portion of the conductor array;

FIG. 7C is a simplified schematic illustration of one embodiment of the temperature controller and a portion of a number of conductor units;

FIG. 8 is a simplified schematic illustration of another embodiment of the temperature controller and a portion of a number of conductor units;

FIG. 9 is an exploded view of another embodiment of the conductor array, the base assembly, the temperature controller, and the control system;

FIG. 10A is a simplified side view of a housing unit having features of the present invention with heat flowing into the housing unit;

FIG. 10B is a simplified side view of the housing unit with heat flowing from the housing unit;

FIG. 10C is a simplified side view of the housing unit and a portion of a conductor unit with heat flowing from the conductor unit into the housing unit;

FIG. 10D is a simplified side view of the housing unit and the conductor unit with heat flowing from the housing unit into the conductor unit;

FIG. 11A is a simplified cut-away view of an assembly having features of the present invention with heat flowing into the assembly;

FIG. 11B is a simplified cut-away view of the assembly with heat flowing from the assembly;

FIG. 12 is a schematic illustration of an exposure apparatus having features of the present invention;

FIG. 13A is a flow chart that outlines a process for manufacturing a device in accordance with the present invention; and

FIG. 13B is a flow chart that outlines device processing in more detail.

### DESCRIPTION

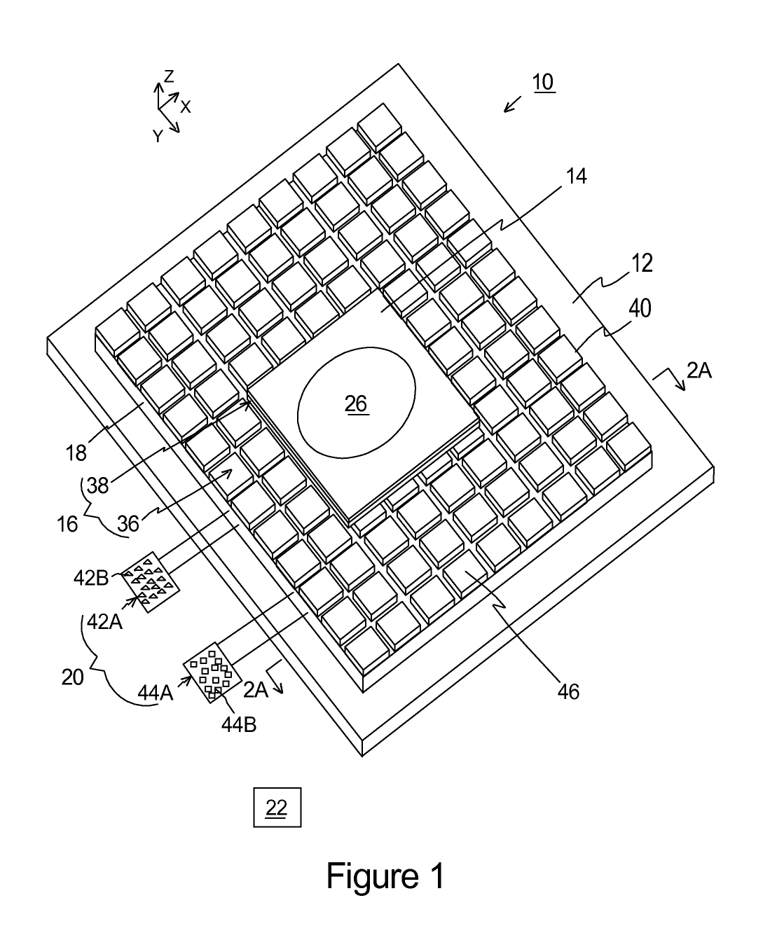

Referring initially to FIG. 1, a stage assembly 10 having features of the present invention includes a stage base 12, a stage 14, a stage mover 16, a base assembly 18, a temperature controller 20, and a control system 22. The design of each of these components can be varied to suit the design requirements of the assembly 10. The stage mover 16 precisely moves the stage 14 relative to the stage base 12 and the base assembly 18. It should be noted that the stage assembly 10 can be designed with more or fewer components than that illustrated in FIG. 1.

As an overview, in certain embodiments, the stage mover 16 and the temperature controller 20 are uniquely designed and controlled to efficiently maintain a substantially uniform temperature of a portion of the stage mover 16, the temperature adjuster 20, and/or the base assembly 18. This can reduce the amount of heat transferred from the stage mover 16 to the surrounding environment. With this design, the stage mover 16 can be placed closer a measurement system (not shown in FIG. 1) used to monitor the position of the stage 14, and/or the thermal influence of the stage mover 16 on the accuracy of the measurement system is reduced. As a result thereof, the stage assembly 10 can position the stage 14 with improved accuracy.

The stage assembly 10 is particularly useful for precisely positioning a device 26 during a manufacturing and/or an inspection process. The type of device 26 positioned and moved by the stage assembly 10 can be varied. For example, the device 26 can be a semiconductor wafer, and the stage assembly 10 can be used as part of an exposure apparatus for precisely positioning the semiconductor wafer during manufacturing of the semiconductor wafer. Alternatively, for example, the device 26 can be a reticle, and the stage assembly 10 can be used for precisely positioning the reticle during manufacturing of a semiconductor wafer. Still alternatively, for example, the stage assembly 10 can be used to move other types of devices during manufacturing and/or inspection, to move a device under an electron microscope (not shown), or to move a device during a precision measurement operation (not shown).

Some of the Figures provided herein include an orientation system that designates an X axis, a Y axis, and a Z axis. It should be understood that the orientation system is merely for reference and can be varied. Moreover, these axes can alternatively be referred to as a first, second, or third axis.

The stage base 12 supports a portion of the stage assembly 10. In FIG. 1, the stage base 12 is rigid and is generally rectangular plate shaped, although other shapes and configurations of the stage base 12 are possible.

The stage 14 retains the device 26. In FIG. 1, the stage 14 is generally rectangular shaped and includes a device holder (not shown) for retaining the device 26. The device holder can be a vacuum chuck, an electrostatic chuck, or some other type of clamp. In FIG. 1, the stage assembly 10 includes a single stage 14. Alternatively, for example, the stage assembly 10 can be designed to include multiple stages that are independently moved relative to the stage base 12.

The stage mover 16 controls and adjusts the position of the stage 14 and the device 26 relative to the base assembly 18 and the stage base 12. For example, the stage mover 16 can be a planar motor that moves and positions of the stage 14 with six degrees of freedom (e.g. along the X, Y, and Z axes, and about the X, Y, and Z axes). Alternatively, the stage mover 16 can be designed to move the stage 14 with fewer than six degrees of freedom. For example, the stage 14 can be maintained along the Z axis with a vacuum preload type fluid bearing or another type of bearing and the stage mover 16 can move the stage 14 with three degrees of freedom (e.g. along the X axis, along the Y axis, and about the Z axis). Still alternatively, the stage mover 16 can be a linear actuator, a rotary actuator, or another type of mover.

In one embodiment, the stage mover 16 is an electromagnetic actuator that includes a conductor array 36 (illustrated as a grid of small boxes) and a magnet array 38 (illustrated as a box). One of the arrays 36, 38 is secured to the top of the base assembly 18 and the other array 36, 38 is secured to the bottom of the stage 14. In FIG. 1, the conductor array 36 is secured to the top of the base assembly 18, and the magnet array 38 is secured to the bottom of the stage 14 to form a “moving magnet” type planar motor. Alternatively, the magnet array 38 can be secured to the top of the base assembly 18, and the conductor array 36 can be secured to the bottom of the stage 14, forming a “moving coil” type planar motor.

In FIG. 1, the conductor array 36 includes a plurality of conductor units 40 that are arranged in a two dimensional, rectangular shaped grid. The number of conductor units 40 in the conductor array 36 can be varied to suit the movement requirements of the stage mover 16. In FIG. 1, the conductor array 36 includes one hundred and eight conductor units 40 that are secured to the base assembly 18 and that are arranged in a twelve by nine grid. Alternatively, the conductor array 36 can be designed to include more than or fewer than one hundred and eight separate conductor units 40.

The magnet array 38 includes a plurality of magnets. The size, shape and number of magnets can be varied to suit the design requirements of the stage mover 16. Each magnet can be made of a permanent magnetic material such as NdFeB.

Electrical current (not shown) is independently supplied to the conductor units 40 by the control system 22. The electrical current in the conductor units 40 interact with the magnetic field(s) of the magnet array 38. This causes a force (Lorentz type force) between the conductor units 40 and the magnet array 38 that can be used to move the stage 14 relative to the stage base 12.

Unfortunately, the electrical current supplied to the conductor array 36 also generates heat, due to resistance in the conductor array 36. Moreover, the resistance of the conductor array 36 increases as temperature increases. This exacerbates the heating problem and reduces the performance and life of the stage mover 16. Heat transferred to the base assembly 18 can cause expansion and distortion. Further, heat transferred to the surrounding environment can adversely influence the measurement system. In certain embodiments, the temperature controller 20 and the conductor array 36 are uniquely designed to efficiently remove the heat and inhibit the transfer of the heat to the base assembly 18 and the surrounding environment.

The base assembly 18 can be any structure, and in certain embodiments, the base assembly 18 receives the reaction forces generated by the stage mover 16. In FIG. 1, the base assembly 18 is a reaction assembly that counteracts, reduces and minimizes the influence of the reaction forces from the stage mover 16 on the position of the stage base 12. This allows for more accurate positioning of the stage 14 and for smaller disturbances to other parts of the apparatus comprising the stage assembly 10. As provided above, the conductor array 36 of the stage mover 16 is coupled to the base assembly 18. With this design, the reaction forces generated by the stage mover 16 are transferred to the base assembly 18. Thus, when the stage mover 16 applies a force to move the stage 14, an equal and opposite reaction force is applied to the base assembly 18.

In FIG. 1, the base assembly 18 is a rigid, rectangular shaped countermass that is maintained above the stage base 12 with a reaction bearing (not shown), e.g. a vacuum preload type fluid bearing, that allows for motion of the countermass base assembly 18 relative to the stage base 12 along the X axis, along the Y axis and about the Z axis. Alternately, for example, the reaction bearing can be a magnetic type bearing, a roller bearing type assembly, and/or the bearing can be designed to allow for movement of the countermass along the X, Y, and Z axes and about the X, Y, and Z axes.

With the present design, (i) movement of the stage 14 with the stage mover 16 along the X axis, generates an equal and opposite X reaction force that moves the countermass base assembly 18 in the opposite direction along the X axis; (ii) movement of the stage 14 with the stage mover 16 along the Y axis, generates an equal and opposite Y reaction force that moves the countermass reaction assembly 18 in the opposite direction along the Y axis; (iii) movement of the stage 14 with the stage mover 16 about the Z axis generates an equal and opposite theta Z reaction moment (torque) that moves the countermass base assembly 18 about the Z axis, and (iv) movement of the stage 14 with stage mover 16 along the X axis or the Y axis may additionally generate a reaction moment (torque) that moves the countermass base assembly 18 about the Z axis.

In certain embodiments, the ratio of the mass of the countermass reaction assembly 18 to the mass of the stage 14 is relatively high. This will minimize the movement of the countermass base assembly 18 and minimize the required travel of the countermass base assembly 18. A suitable ratio of the mass of the countermass base assembly 18 to the mass of the stage 14 is between approximately 2:1 and 20:1. In one embodiment which is particularly suited to use in a moving magnet configuration, the countermass base assembly 18 comprises components made from a non-electrically conductive, non-magnetic material, such as low electrical conductivity stainless steel or titanium, or non-electrically conductive plastic or ceramic. The use of non-magnetic material in the countermass base assembly 18 reduces undesirable cogging forces acting on the stage 14, and the use of low- or non-electrically conductive material reduces eddy current drag forces on the stage 14.

The temperature controller 20 reduces the influence of the heat from the conductor array 36 from adversely influencing the other components of the stage assembly 10. For example, the temperature controller 20 can efficiently reduce the amount of heat transferred from the conductor array 36 to the surrounding environment. In one embodiment, the temperature controller 20 includes (i) a first temperature system 42A (illustrated as a box) and (ii) a second temperature system 44A (illustrated as a box) that are used to control the temperature of at least a portion of the conductor array 36. It should be noted that the first temperature system 42A can also be referred to as a body temperature system, and the second temperature system 44A can be referred to as a surface temperature system.

In one embodiment, (i) the first temperature system 42A directs a first circulation fluid 42B (illustrated as small triangles) around the conductor array 36 to remove the majority of the heat created by the conductor units 40, and (iii) the second temperature system 44A directs a second circulation fluid 44B to the conductor array 36 to function as an insulator that inhibits the transfer of heat from the conductor array 36 to the surrounding environment. With this design, the temperature of an outer surface 46 of the conductor array 36 is easier to maintain at a predetermined temperature. One or both of the temperature systems 42A, 44A can include one or more pumps, reservoirs, heat exchanges, chillers, pressure controllers, manifolds, and/or valves. In FIG. 1, the outer surface 46 is the upper surface of the conductor array 36 that faces and that is adjacent to the magnet array 38.

It should be noted that the first circulation fluid 42B can also be referred to as a body circulation fluid, and the second circulation fluid can also be referred to as a surface circulation fluid. The circulation fluids 42B, 44B also be referred to as a coolant. The type of circulation fluid 42B, 44B can be varied. For example, each circulation fluid 42B, 44B can be water or Fluorinert.

The control system 22 is electrically connected to, directs and controls electrical current to the conductor array 36 of the stage mover 16 to precisely position the device 26. Further, in the embodiment illustrated in FIG. 1, the control system 22 is electrically connected to and controls (i) the first temperature system 42A to control the temperature, flow rate and/or pressure of the first circulation fluid 42B directed into the conductor array 36, and/or (ii) the second temperature system 44A to control the temperature, flow rate and/or pressure of the second circulation fluid 44B directed into the conductor array 36. The control system 22 can include one or more processors and circuits.

Typically, depending upon the type of movement required for the stage assembly 10, more current is directed to certain conductor units 40 than other conductor units 40 in the conductor array 36. Thus certain conductor units 40 will generate more heat and will require more cooling than other conductor units.

In certain embodiments, the first temperature system 42A and/or the second temperature system 44A are uniquely designed to provide more cooling to certain conductor units 40 or certain portions of certain conductor units 40. More specifically, in certain embodiments, the temperature controller 20 will adjust the rate in which heat is removed or added to certain zones in the conductor array 36 based on how much each conductor unit 40 is or will be utilized. For example, the first temperature system 42A can adjust the rate in which heat is removed or added to a particular zone based on the usage of the one or more conductors in that zone, while the second temperature system 44A directs the surface circulation fluid 44B at the same rate and temperature to each of the conductor units 40 regardless of which conductor units 40 generate more heat. Alternatively, the second temperature system 44A can also be designed to adjust the rate in which heat is removed or added depending upon the usage of the conductors in the respective zone.

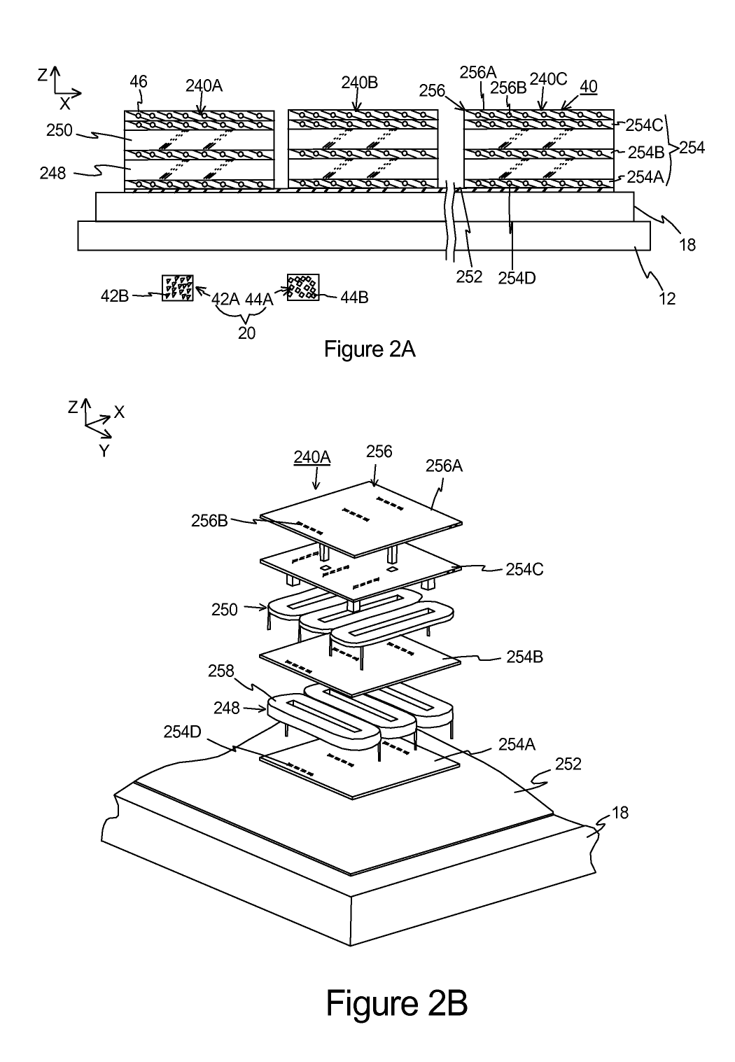

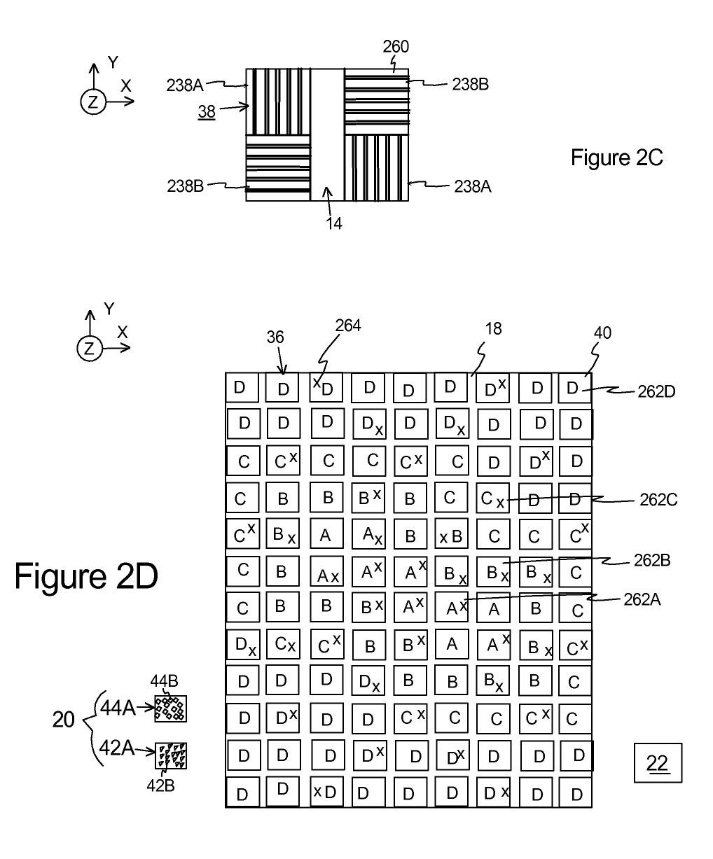

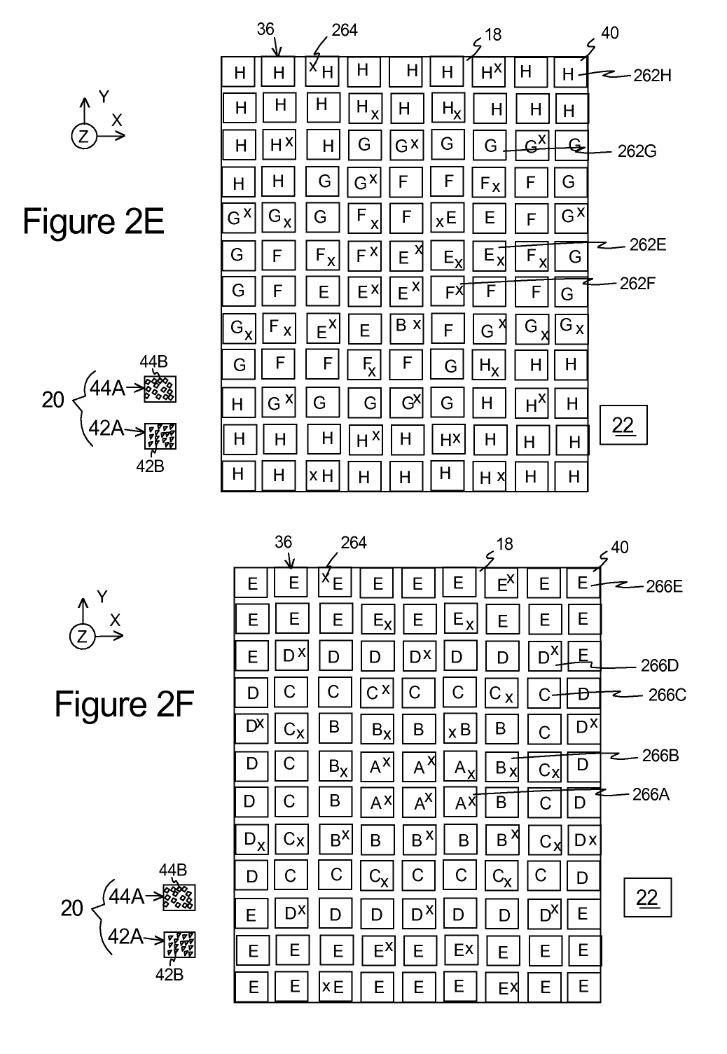

FIG. 2A is a cut-away view taken on line 2A-2A in FIG. 1 illustrating (i) a portion of the stage base 12, (ii) a portion of the base assembly 18, and (iii) three conductor units 40. The temperature adjuster 20 is also illustrated in FIG. 2A. In this embodiment, moving left to right, the conductor units 40 can be referred to a first conductor unit 240A, a second conductor unit 240B, and a third conductor unit 240C for ease of discussion.

In FIG. 2A, each conductor unit 240A, 240B, 240C includes a lower, first coil set 248 and an upper second coil set 250 that is spaced apart from the first coil set 248. Alternatively, each conductor unit 240A, 240B, 240C can be designed to have a single coil set or more than two coil sets 248, 250. In FIG. 2A, the conductor array 36 also includes (i) a circuit board 252 for directing current to the conductor units 40, (ii) a body heat exchanger assembly 254 that is used to remove the bulk of the heat from the conductor units 40, and (iii) a surface heat exchanger assembly 256 that is used to maintain the outer surface 46 at the desired temperature. The design of each heat exchanger assembly 254, 256 can be varied.

In FIG. 2A, for each conductor unit 40, the body heat exchanger assembly 254 includes (i) a lower, first body heat exchanger 254A positioned between the circuit board 252 and the first coil set 248, (ii) a middle, second body heat exchanger 254B positioned between the first coil set 248 and the second coil set 250, and (iii) an upper, third body heat exchanger 254C positioned above the second coil set 250. Alternatively, for example, each conductor unit 40 can include more than three or fewer than three body heat exchangers, and/or multiple conductor units 40 can share one or more common body heat exchangers.

Still alternatively, one or more of the body heat exchangers 254A, 254B, 254C can span multiple conductor units 40. In yet another alternative embodiment, one or more of the body heat exchangers 254A, 254B, 254C can encircle or enclose (i) a portion of, or all of one or more coil sets 248, 250, and/or (ii) a portion of, or all of one or more conductor units 40.

In the non-exclusive embodiment illustrated in FIG. 2A, each body heat exchanger 254A, 254B, 254C is rigid and generally rectangular plate shaped and includes one or more flow channels 254D that weave back and forth in a serpentine pattern in the respective plate. In this embodiment, each flow channel 254D can be a micro-channel (e.g. a very small channel). With this design, the first temperature system 42A is in fluid communication with the body heat exchangers 254A, 254B, 254C and can direct the first circulation fluid 42B at high pressure and a high flow rate through the body heat exchangers 254A, 254B, 254C without distorting the body heat exchangers 254A, 254B, 254C. This feature allows the first fluid system 42A to remove the bulk of the heat from the conductor units 40. As non-exclusive examples, the pressure in each flow channel 254D can be between approximately ten psi and fifty psi, and/or the flow rate in each flow channel 254D can be between approximately 0.1 and 2.0 liters/minute.

Further, in FIG. 2A, for each conductor unit 40, the surface heat exchanger assembly 256 includes a surface heat exchanger 256A positioned on the top of the upper, third exchanger 254C. Alternatively, for example, multiple conductor units 40 can share a common surface exchanger 256A or the surface exchanger can enclose or encircle one or more conductor units 40. Still alternatively, the surface heat exchanger 256A can include multiple layers of heat exchangers stacked on each other.

In FIG. 2A, the surface heat exchanger 256A is generally plate shaped and includes one or more flow channels 256B that weave back and forth in a serpentine pattern in the respective plate. In this embodiment, each flow channel 256B can be a micro-channel (e.g. a very small channel). With this design, the second temperature system 44A is in fluid communication with the surface exchangers 256A, and can direct the second circulation fluid 44B at high pressure and a high flow rate through the surface exchangers 256A without distorting the surface exchangers 256A. As non-exclusive examples, the pressure in each flow channel 256B can be between approximately ten psi and fifty psi, and/or the flow rate in each flow channel 256B can be between approximately 0.1 and 2.0 liter/minute.

In one embodiment, the flow channel 254D of each body heat exchanger 254A, 254B, 254C flows back and forth through the respective body heat exchanger 254A, 254B, 254C. Alternatively, one or more of the body heat exchangers 254A, 254B, 254C can include multiple alternative flow channels 254D in which flow is independently controlled. For example, the body heat exchangers 254A, 254B, 254C can each include three different flow channels 254D that define three separate heat exchangers. This design can be used for the independent cooling of each coil. In many instances, a center coil 258 in each three coil set 248, 250 will require the more cooling than the side coils 258.

In one embodiment, each heat exchanger 254A, 254B, 254C, 256A can be made of a low-electrically conductive, non-magnetic material, such as titanium, or non-electrically conductive plastic or ceramic. Further, each heat exchanger 254A, 254B, 254C, 256A can be made by welding or bonding two half plates together. In this example, for each heat exchanger 254A, 254B, 254C, 256A, each half plate can include a portion of the channel etched into the half plate. Subsequently, the half plates can be assembled to create the channels. As a non-exclusive embodiment, each flow channel 254D, 256B can have cross-section dimensions (perpendicular to the fluid flow) of approximately a few microns wide up to a few hundreds of microns in the Z direction and between one and twenty millimeters in the XY plane. Stated in another fashion, each micro channel 254D, 256B can have a cross-section area (perpendicular to the direction of fluid flow) of between approximately 0.01 and 5 square millimeters. Stated in yet another fashion, each micro channel 254D, 256B can have a cross-section area of less than approximately 0.01, 0.05, 0.1, 0.5, 1, 2, 3, 4, or 5 square millimeters

With the present design, in certain embodiments, the second circulation fluid 44B flowing in the surface exchanger assembly 256 removes very little heat, but provides a thermal shield for the outer surface 46. Further, with this design, because the second circulation fluid 44B removes very little heat, the second circulation fluid 44B traveling through the surface exchanger assembly 256 will experience very little temperature increase (delta T). With this design, the temperature of the second circulation fluid 44B at the inlet to the surface exchanger assembly 256 can be controlled to be approximately equal to the predetermined desired temperature. As a non-exclusive example, the change in temperature of the second circulation fluid 44B from flow through the surface exchanger assembly 256 can be less than approximately one degree centigrade. With this small delta T, there is only a very minimal thermal gradient on the outer surface 46, and very minimal thermal distortion.

FIG. 2B is an exploded perspective view of one embodiment of a single conductor unit 240A of FIG. 2A including the coil sets 248, 250 and the heat exchangers 254A, 254B, 254C, 256A. A portion of the channels 254D, 256B are illustrated in phantom in FIG. 2B. The circuit board 252, and a portion of the base assembly 18 are also illustrated in FIG. 2B. The other conductor units in the conductor array 36 can be similar to the conductor unit 240A illustrated in FIG. 2B. Alternatively, the conductor units can have a different design than that illustrated in FIG. 2B.

The design of each coil set 248, 250 and the number of conductors in each coil set 248, 250 can be varied to suit the design requirements of the stage mover 16. In FIG. 2B, for a three phase linear motor, each coil set 248, 250 can include three adjacent racetrack shaped coils 258 that are aligned side by side. Alternatively, each coil set 248, 250 can include fewer than three or more than three coils 258. Each coil can be made of metal such as copper or any substance or material responsive to electrical current and capable of creating a magnetic field such as superconductors.

In one embodiment, (i) the first coil set 248 can also be referred to as a X coil set because current directed to the first coil set 248 is used to generate a force along the X axis; and (ii) the second coil set 250 can also be referred to as a Y coil set because current directed to the second coil set 250 is used to generate a force along the Y axis. Alternatively, conductor units can alternate in a checkerboard pattern between Y conductor units and X conductor units. In this example, (i) for each Y conductor unit, both coil sets would be Y coil sets, and (ii) for each X conductor unit, both coil sets would be X coil sets.

Moving from the bottom to the top in FIG. 2B, the components of the conductor unit 240A are assembled as follows, (i) the lower first heat exchanger 254A is positioned adjacent to and above the printed circuit board 252; (ii) the first coil set 248 is positioned adjacent to, above, and in direct thermal contact with the lower first heat exchanger 254A; (iii) the middle second heat exchanger 254B is positioned adjacent to, above, and in direct thermal contact with the first coil set 248; (iv) the second coil set 250 is positioned adjacent to, above, and in direct thermal contact with the middle lower heat exchanger 254B; (v) the upper third heat exchanger 254C is positioned adjacent to, above, and in direct thermal contact with the second coil set 250; and (vi) the surface heat exchanger 256A is positioned adjacent to, above, and in direct thermal contact with the upper heat exchanger 254C.

FIG. 2C is a bottom view of the stage 14 and one embodiment of the stage 14 and the magnet array 38 of FIG. 1. In this embodiment, the magnet array 38 including a spaced apart pair of X magnet sets 238A, and a spaced apart pair of Y magnet sets 238B that are secured to the stage 14. In this embodiment, (i) each Y magnet set 238B includes a plurality of magnets 260 that extend along the X axis and that are spaced apart along the Y axis; and (ii) each X magnet set 238A includes a plurality of magnets 260 that extend along the Y axis and that are spaced apart along the X axis.

With this design, (i) current can be directed to the X coil sets 248 (illustrated in FIG. 2A) positioned near the X magnet sets 238A to generate a controllable X axis force, and (ii) current can be directed to the Y coil sets 250 (illustrated in FIG. 2A) positioned near the Y magnet sets 238B to generate a controllable Y axis force. The coil sets 248, 250 that will be used will change as the stage 14 is moved. Stated in another fashion, depending upon the type of movement, more current is directed to certain coil sets 248, 250 than other coil sets 248, 250 in the conductor array 36. These coil sets 248, 250 will generate more heat and will require more cooling.

As provided herein, the conductor array 36 can be divided into a plurality of different zones, and the zones can be cooled at different rates. For example, each zone can include (i) a single coil set 248, 250; (ii) multiple coil sets 248, 250 having similar usages; (iii) a single conductor unit 40; (iv) a single coil 258, or (v) multiple conductor units 40 having somewhat similar usages. As provided herein, the first temperature system 42A and/or the second temperature system 44A can individually control the flow rate and temperature of the circulation fluid 42B, 44B directed to each zone.

In certain embodiments, each zone will require separate valves for the temperature control. Generally speaking, as the number of zones is increased, the required number of valves is increased and is more complicated. However, generally, as the number of zones is increased, the overall coolant flow is reduced because of the efficiency of the temperature control.

In one embodiment, the zones could be delineated by calculating the total heat generated by various coil sets 248, 250 during the planned usage for the stage assembly 10. FIGS. 2D and 2E are simplified top views of the base assembly 18, the conductor array 36 including a plurality of conductor units 40, and a schematic of the temperature adjuster 20, and the control system 22. In this embodiment, the conductor array 36 and the base assembly 18 are divided (grouped) into different zones depending upon the projected heat generated by each coil set 248, 250 (illustrated in FIG. 2A) during the planned movement. More specifically, the conductor units 36 can be divided into eight different zones, namely (i) four alternative X zones 262A-262D (illustrated in FIG. 2D) based on the heat generated by the X coil sets 248 for the planned usage, and (ii) four alternative Y zones 262E-262H (illustrated in FIG. 2E) based on the heat generated by the Y coil sets 250 for the planned usage.

In this embodiment, the different X zones include (i) a first zone 262A (represented with conductor units labeled “A”); (ii) a second zone 262B (represented with conductor units labeled “B”); (iii) a third zone 262C (represented with conductor units labeled “C”); and (iv) a fourth zone 262D (represented with conductor units labeled “D”). Further, the Y zones include (i) a fifth zone 262E (represented with conductor units labeled “E”); (ii) a sixth zone 262F (represented with conductor units labeled “F”); (iii) a seventh zone 262G (represented with conductor units labeled “G”); and (iv) an eighth zone 262H (represented with conductor units labeled “H”).

In this example, (i) the X coil sets 248 that are part of the first zone 262A are used the most (of the X coil sets 248), require the most cooling, and are grouped together; (ii) the X coil sets 248 that are part of the second zone 262B are used the second most (of the X coil sets 248), require the second most cooling, and are grouped together; (iii) the X coil sets 248 that are part of the third zone 262C are used the third most, require the third most cooling (of the X coil sets 248), and are grouped together; and (iv) the X coil sets 248 that are part of the fourth zone 262D are used the least, require the least cooling (of the X coil sets 248), and are grouped together.

Somewhat similarly, (i) the Y coil sets 250 that are part of the fifth zone 262E are used the most (of the Y coil sets 250), require the most cooling, and are grouped together; (ii) the Y coil sets 250 that are part of the sixth zone 262F are used the second most (of the Y coil sets 250), require the second most cooling, and are grouped together; (iii) the Y coil sets 250 that are part of the seventh zone 262G are used the third most (of the Y coil sets 250), require the third most cooling, and are grouped together; and (iv) the Y coil sets 250 that are part of the eighth zone 262H are used the least (of the Y coil sets 250), require the least cooling, and are grouped together. It should be noted that comparing FIGS. 2D and 2E that the X zones 262A-262D and the Y zones 262E-262H are partly overlapping but are slightly different.

In certain embodiments, the body temperature system 42A and/or the surface temperature system 44A can adjust the flow rate and/or the temperature of the coolant 42B, 44B (i) to the zones 262A-262H where more cooling is needed, and (ii) less to the zones 262A-262H where less cooling is needed. Stated in another fashion, in certain embodiments, the temperature controller 20 will adjust the rate in which heat is removed or added to certain zones 262A-262H (e.g. individual coils 258 or individual coil units).

For example, in one embodiment, the body temperature system 42A can adjust the rate in which heat is removed or added to a particular zones 262A-262H based on the usage of the conductors in that zones 262A-262H, while the surface temperature system 44A directs the second circulation fluid 44B at the same rate and temperature to each of the conductor units 40 regardless of which conductor units 40 generate more heat. In this example, (i) the body temperature system 42A directs the circulation fluid 42B to each zone 262A-262H to remove the heat generated within that zone 262A-262H; and (ii) the surface temperature system 44A directs the surface circulation fluid 44B to maintain the upper, outer surface 46 of each conductor unit 40 at the desired temperature. With this design, the flow rate and/or temperature of the first circulation fluid 42B can be individually adjusted to each zone 262A-262H (as needed based on the power consumption) to remove the majority of the heat, and the second circulation fluid 44B is used as a thermal shield to maintain the outer surface 46 to inhibit the transfer of heat from each conductor unit 40.

Alternatively, the surface temperature system 44A can also be designed to adjust the rate in which heat is removed or added depending upon the usage of the conductors in the respective zones 262A-262H. Still alternatively, the conductor units 40 can be grouped into more than eight or fewer than eight zones, and/or the shapes of the zones can be different.

Additionally, each of the zones 262A-262H can include one or more feedback elements 264 (illustrated with an X) that can provide feedback to the control system 22 regarding the respective zone 262A-262H for controlling the temperature adjuster 20. For example, each feedback element 264 can be a temperature sensor (e.g. a thermocouple or thermistor) that provides the temperature of a portion or substantially all of the respective zone 246A-246E. In one embodiment, multiple temperature sensors 264 in a zone can be averaged to determine an average temperature of that zone. Subsequently, this feedback can be provided to the control system 22 so that the control system 22 can precisely control the temperature controller 20. It should be noted that the temperature system 42A, 44A can include separate feedback systems.

It should be noted that the conductor array 36 can be divided into different zones than those illustrated in FIGS. 2D and 2E. FIG. 2F is a simplified top view of the base assembly 18, the conductor array 36 including a plurality of conductor units 40, the temperature adjuster 20, and the control system 22. In this embodiment, the conductor array 36 is divided (grouped) into different zones depending upon the projected heat generated by each conductor unit 40 and their respective cooling requirements.

In FIG. 2F, the conductor array 36 is divided into five separate zones based on the heat generated by the conductor units 40 during the planned movement. More specifically, the conductor array 36 is divided into (i) a first zone 266A (represented with conductor units labeled “A”) that includes six conductor units 40; (ii) a second zone 266B (represented with conductor units labeled “B”) that includes fourteen conductor units 40; (iii) a third zone 266C (represented with conductor units labeled “C”) that includes twenty-two conductor units 40; (iv) a fourth zone 266D (represented with conductor units labeled “D”) that includes twenty-six conductor units 40; and (v) a fifth zone 266E (represented with conductor units labeled “E”) that includes forty conductor units 40.

For this particular planned movement, (i) the conductor units 40 that are part of the first zone 266A are used the most and require the most cooling; (ii) the conductor units 40 that are part of the second zone 266B are used the second most and require the second most cooling; (iii) the conductor units 40 that are part of the third zone 266C are used the third most and require the third most cooling; (iv) the conductor units 40 that are part of the fourth zone 266D are used the fourth most and require the fourth most cooling; and (v) the conductor units 40 that are part of the fifth zone 266E are used the least and require the least cooling. Thus, the conductor units 40 are divided into groups that are high power, medium-high power, medium power, medium-low power, and low power zones.

With this design, the body temperature system 42A and/or the surface temperature system 44A can adjust the temperature and/or flow rate of the coolant 42B, 44B (i) to each of the zones 266A-266E of the conductor array 36 where more cooling is needed, and (ii) less to the zones 266A-266E of the conductor array 36 where less cooling is needed to adjust the rate in which heat is removed or added to certain zones 266A-266E. In one embodiment, the body temperature system 42A can adjust the rate in which heat is removed or added to the zones 266A-266E based on the usage, while the surface temperature system 44A directs the second circulation fluid 44B at the same rate and temperature to each of the conductor units 40 regardless of usage. Additionally, or alternatively, the surface temperature system 44A can independently adjust the pressure and flow rate of the second circulation fluid 44B that is into a number of different zones.

Additionally, in FIG. 2F, each of the zones 266A-266E can again include one or more feedback elements 264 (illustrated with an X) that can provide feedback regarding the respective zone 266A-266E.

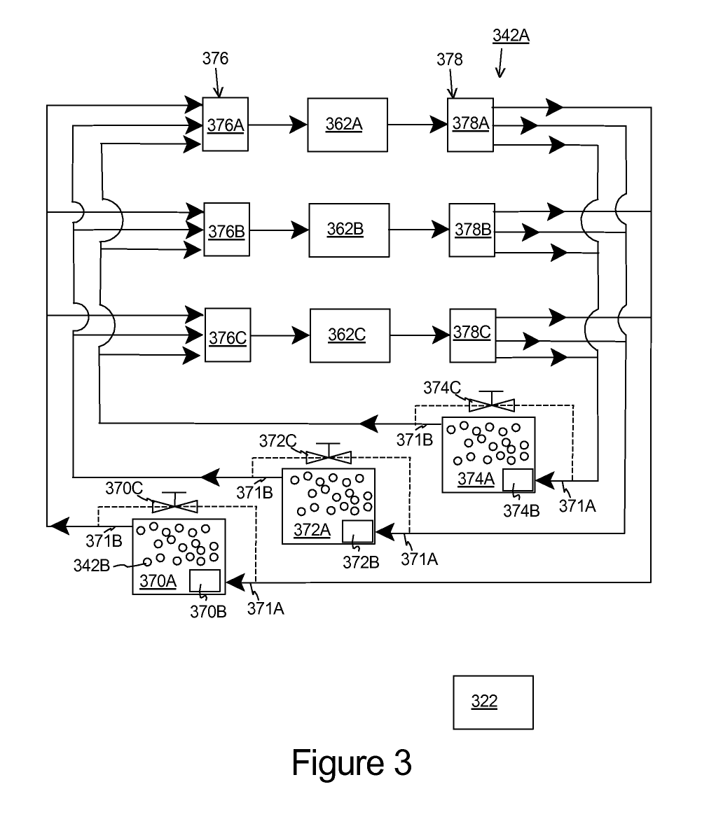

FIG. 3 is a simplified illustration of a first zone 362A, a second zone 362B, a third zone 362C (all illustrated as boxes), and one non-exclusive example of a first temperature system 342A having features of the present invention. It should be noted that only three zones are illustrated in FIG. 3 for reference and that the conductor array can be divided into fewer than or more than three separate zones. In this embodiment, each zone 362A, 362B, 362C can include (i) a single coil set; (ii) multiple coil sets having similar usages; (iii) a single conductor unit; or (iii) multiple conductor units having somewhat similar usages. In this embodiment, the first temperature system 342A selectively and independently controls the flow rate and temperature of the first circulation fluid 342B (illustrated as circles) to each zone 362A, 362B, 362C. Thus, the first temperature system 342A independently adjusts the temperature of each of the zones 362A, 362B, 362C.

The design of the body temperature system 342A can vary pursuant to the teachings provided herein. In FIG. 3, the body temperature system 342A includes (i) a first temperature unit 370A that controls the temperature of the circulation fluid 342B to be at a first temperature when it exits the first temperature unit 370A; (ii) a second temperature unit 372A that controls the temperature of the circulation fluid 342B to be at a second temperature when it exits the second temperature unit 372A; and (iii) a third temperature unit 374A that controls the temperature of the circulation fluid 342B to be at a third temperature when it exits the third temperature unit 374A. With this design, the first temperature is different from the second temperature and the third temperature, and the second temperature is different from the third temperature. The differences between the temperatures can vary. As provided herein, (i) the first temperature can be the coldest and can be referred to as the cold fluid or low temperature coolant; (ii) the second temperature can be the next coldest and can be referred to as the medium fluid or the medium temperature coolant; and (iii) the third temperature can be the hottest and can be referred to as the hot fluid or the high temperature coolant.

In one, non-exclusive embodiment, (i) the first temperature is lower (colder) than the desired temperature setpoint of the zones 362A-362C, (ii) the second temperature is approximately equal to the temperature setpoint of the zones 362A-362C, and (iii) the third temperature is greater (hotter) than the setpoint of zones 362A-362C. For example, the setpoint can be twenty degrees Celsius, the first temperature can be approximately ten degrees Celsius, the second temperature can be approximately twenty degrees Celsius, and the third temperature can be approximately thirty degrees Celsius. Alternatively, the temperatures can be different from these examples. Still alternatively, the body temperature system 342A can be modified to use only two alternative temperature coolants or more than three alternative temperature coolants.

As provided herein, each temperature unit 370A, 372A, 374A can include one or more chiller/heat exchangers 370B, 372B, 374B (illustrated as a box), heat exchanger, pumps, reservoirs, and/or valves. Further, each temperature unit 370A, 372A, 374A can include an inlet 371A and an outlet 371B.

In one embodiment, the first temperature system 342A can include an inlet valve assembly 376 that independently controls the flow rate and temperature of the circulation fluid 342B directed to each of the zones 362A-362C, and an outlet valve assembly 378 that routes the circulation fluid 342B exiting the respective zone 362A, 362B, 362C to the desired temperature unit 370A, 372A, 374A. In one embodiment, the inlet valve assembly 376 includes a separate inlet valve group, and the outlet valve assembly includes a separate outlet valve group for each zone 362A, 362B, 362C.

More specifically, in FIG. 3, the inlet valve assembly 376 includes (i) a first inlet valve group 376A that independently controls the temperature and flow rate of the circulation fluid 342B to the first zone 362A by controlling how much of the first temperature, the second temperature, and the third temperature circulation fluid 342A is directed to the first zone 362A; (ii) a second inlet valve group 376B that independently controls the temperature and flow rate of the circulation fluid 342B to the second zone 362B by controlling how much of the first temperature, the second temperature, and the third temperature circulation fluid 342B is directed to the second zone 362B; and (iii) a third inlet valve group 376C that independently controls the temperature and flow rate of the circulation fluid 342B to the third zone 362C by controlling how much of the first temperature, the second temperature, and the third temperature circulation fluid 342B is directed to the third zone 362C.

Somewhat similarly, the outlet valve assembly 378 includes (i) a first outlet valve group 378A which routes the circulation fluid 342B exiting the first zone 362A to the desired temperature unit 370A, 372A, 374A; (ii) a second outlet valve group 378B which routes the circulation fluid 342B exiting the second zone 362B to the desired temperature unit 370A, 372A, 374A; and (iii) a third outlet valve group 378C which routes the circulation fluid 342B exiting the third zone 362C to the desired temperature unit 370A, 372A, 374A.

With this design, the control system 322 can control the inlet valve assembly 376 so that at any given time, the circulation fluid 342B directed into a zone 362A-362C can be (i) all at the first temperature, (ii) all at the second temperature, (iii) all at the third temperature, or (iv) any mixture/ratio of any two or three temperature fluids. Thus, the temperature control is achieved by actively controlling the flow rate of three alternative temperature coolants 342B through each zone 362A-362C.

As provided herein, each valve group 376A-376C and 378A-378C can include one or more valves. For example, one or more of the valves can be an electronic on/off valve that controls the flow rate by controlling the on time and off time to adjust the flow rate. In another embodiment, one or more of the valves can be a motorized metering valve. It should be noted that the valve groups 376A-378C can be located wherever convenient and should be as close as possible to the respective zones 362A-362C to reduce time delay. For example, the valve groups 376A-378C can be positioned in the base assembly 18 and/or integrated in the conductor array 36.

When multiple different temperature coolants are used, the outlet valve assembly 378 is used in order to run the chiller/heat exchanger 370B, 372B, 374B of each temperature unit 370A, 372A, 374A at high efficiency. In contrast, if the body temperature system 342A is designed without the outlet valve assembly, the circulation fluid 342B exiting the zones 362-362C can be returned to a common reservoir tank (not shown).

In one embodiment, the control system 322 controls the outlet valve assembly 378 to direct the circulation fluid 342B exiting the zones 362A-362C to the appropriate temperature unit 370A, 372A, 374A for efficient usage. For example, the control system 322 controls the outlet valve assembly 378 so that (i) if the outlet temperature is not too different from inlet temperature, then the circulation fluid 342B exiting the zone is send the temperature unit it came from; (ii) if the outlet temperature is significantly colder/hotter than inlet temperature then the circulation fluid 342B exiting the zone is diverted to different temperature unit depending on the temperature (to prevent mixing of hot and cold coolant).

As detailed above, in one example, the hot is thirty degrees Celsius, the medium is twenty degrees Celsius, and the cold is ten degrees Celsius. In this example, if the cold coolant is sent to a zone and the outlet temperature of circulation fluid 342B from the zone is at approximately twenty degrees Celsius, then the exiting circulation fluid 342B is directed to the medium temperature unit 372A. Alternatively, if the medium coolant is sent to a zone, and the outlet temperature of circulation fluid 342B from the zone is at approximately twenty degrees Celsius, then the exiting circulation fluid 342B is again directed to the medium temperature unit 372A. At the same time, the control system 322 can control the outlet valve assembly 378 so that not too much or too little circulation fluid 342B is directed to each of the temperature units 370A, 372A, 374A.

As non-exclusive examples, the control system 322 can direct the following valve actuation sequences: (i) when the hot inlet is open, the corresponding hot outlet is also open (similarly for medium and cold coolants), ensuring that the amount of fluid drawn from each temperature unit outlet 371B is returned to the corresponding inlet 371A; or (ii) the inlet and outlet valves are not synchronized together, so that circulation fluid from each temperature unit 370A, 372A, 374A may be returned to a different temperature unit 370A, 372A, 374A. In the second sequence, the inlet valve assembly 376 can open based on the expected or measured temperature of the respective zone 362A-362C, and the outlet valve assembly 378 may open based on the expected or measured exit temperature of fluid 342B. However in this case, steps must be taken to make sure that each temperature unit is supplied with an appropriate amount of circulation fluid 342B, and none of the temperature units are allowed to overflow or underfill.

Additionally, in certain embodiments, (i) the first temperature unit 370A can include a first active bypass valve 370C that can be controlled to selectively direct the flow of the first circulation fluid 334B from the outlet 371B to the inlet 371A of the first temperature unit 370A, (ii) the second temperature unit 372A can include a second active bypass valve 372C that can be controlled to selectively direct the flow of the first circulation fluid 334B from the outlet 371B to the inlet 371A of the second temperature unit 372A, and (iii) the third temperature unit 374A can include a third active bypass valve 374C that can be controlled to selectively direct the flow of the first circulation fluid 334B from the outlet 371B to the inlet 371A of the third temperature unit 374A.

The chiller/heat exchangers 370B, 372B, 374B typically have a certain minimum flow rate required for their efficient operation. The bypass valves 370C, 372C, 374C can be used at the supply and return of the chiller/heat exchangers 370B, 372B, 374B to ensure their continuous operation even when the flow between a particular temperature unit 370A, 372A, 374A and the zones 362A-362C is approximately zero. More specifically, the bypass valves 370B, 372B, 374B at the chiller may be required because at certain times, the flow of the circulation fluid to the zones can be zero.

As provided above, in order to increase the flow of the circulation fluid to the zones, the bypass valve and the valve assemblies can be operated in a complementary fashion (for example: if medium valve is open fully at inlet of zone then bypass valve for medium temp chiller can be closed so that most of the flow is going to the zone). As an example, at a particular time, if there is no flow of the cold coolant to the zones, the first bypass valve 370C can be opened so that the circulation fluid 342B exiting the first temperature unit 370A through outlet 371B can be rerouted (via the first bypass valve 370B) to the inlet 371A of the first temperature unit 370A to maintain the flow of the circulation fluid 342B in the first temperature unit 370A. Subsequently, when the cold coolant is required in the zones, the first bypass valve 370B can be selectively closed so that maximum cold coolant flow can be directed to the zones.

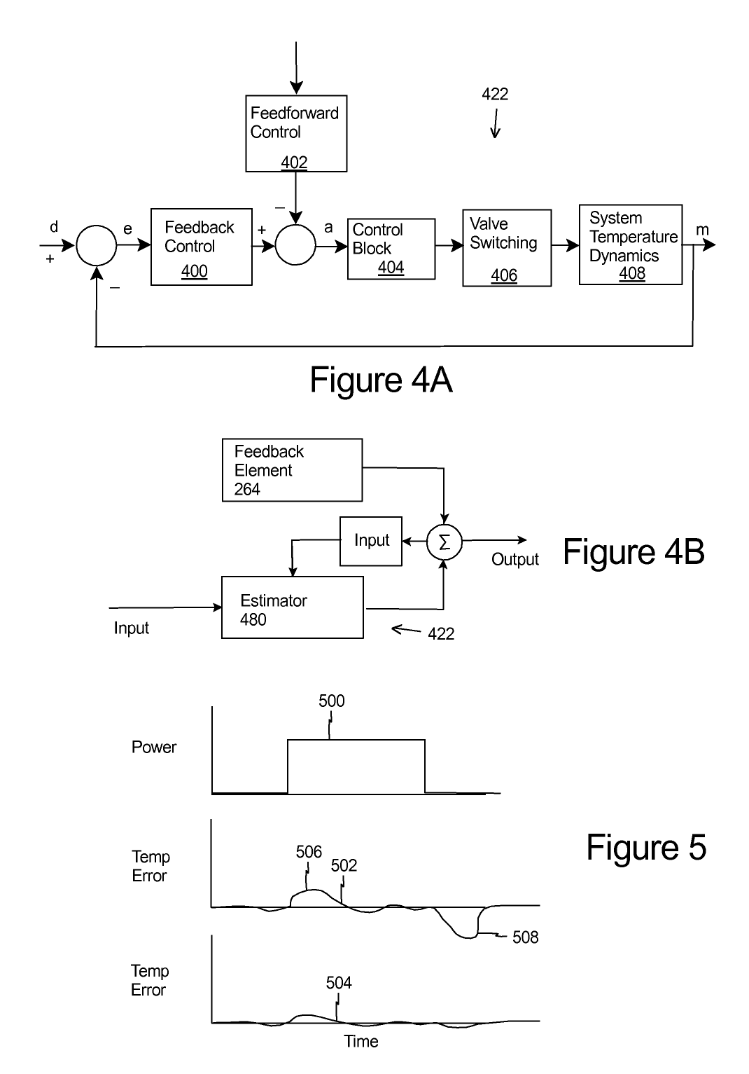

FIG. 4A is a simplified control block diagram of a control system 422 that can be used to control the temperature controller 20 (illustrated in FIG. 1). For example, the control system 422 can selectively control the first temperature system 342A (illustrated in FIG. 3) and the valve assemblies 376, 378 (illustrated in FIG. 3) to selectively and independently control the temperature of each zones 362A-362C (illustrated in FIG. 3).

In FIG. 4A, (i) “d” represents a desired surface temperature setpoint of the zone at a particular moment in time; (ii) “m” represents the measured, actual momentary, temperature from the feedback assembly at a particular moment in time; and (iii) “e” represents a temperature error (“error feedback”) between the desired surface temperature “d” and the measured temperature “m” at a particular moment in time. The measured temperature m can be the temperature of a conductor or a zone that includes multiple conductors or conductor units. For example, the measured temperature can be a weighted average of temperature of multiple thermistors in a zone. In certain embodiments, the weights in a weighted average can be prioritized based on where the sensor is located. For example, a sensor located near an edge coil unit within the zone can possibly have a lower weight, while a sensor located near a center coil unit in a center of the zone can have a higher weight.

In FIG. 4A, starting at the left side of the control block diagram, the desired temperature “d” is fed into the control system 422 along with the measured temperature “m”. Next, the control system 422 determines the temperature error “e”. Subsequently, the temperature error “e” is fed into a feedback control 400 of the control system 422. The feedback control 400 determines the heat/cooling commands that are necessary to correct the temperature error. The feedback control 400 may be in the form of a PID (proportional integral derivative) controller, proportional gain controller with a lead-lag filter, or other commonly known law in the art of control, for example.

Additionally, in FIG. 4A, the control system 422 includes a feedforward control block 402. In certain embodiments, the feedforward block 402 is used to reduce the transient delay in the temperature control and to reduce the influence of disturbance (heat generating events) on the control of the system. During movement of the stage, the heat requirements of the individual zones are known. In certain instances, the feedforward block 402 is used to begin adjustment of the temperature in each zone prior to the actual heat being generated. This reduces the transient delay of the system. Basically, the feedforward control 402 is used to actuate the valves ahead of time depending on the time delay between valve opening and fluid reaching zones. In certain embodiments, the feedforward 402 is also used to activate the valves based on heat generated at the coils.

Next, in FIG. 4A, the feedforward block 402 and the feedback control 400 are combined to generate “a” that is fed into control block 404 that is used to determine the how much to open and close the valves. In one embodiment, the parameter “a” is a linear combination of the output of feedforward gain 402 and output of the feedback gain 400. Block 404 converts the output from the controller “parameter a” that is a function of temperature error and feedforward into a different parameter that can be used control the flow. For example, “parameter a” can be converted into a heat transfer amount that needs to occur to achieve the desired temperature correction in the zone. Feedforward is proportional to the expected heat generated by the coils.

Subsequently, at block 406, the valve switching necessary to achieve the desired temperature and flow rate of the circulation fluid to the respective zones are determined. Basically, the valve switching determines which valves and how much these valves need to be open to achieve the desired temperature correction. As non-exclusive examples, the valves can be digital (pulse wave modulated) or analog (infinitely variable).

Next, block 408 represents the system temperature dynamics that results from the flow of the circulation fluid through the respective zones and from the heat dissipation of the stage mover 16.

In this embodiment, the feedback control 400 is constantly correcting for errors all the time, and in parallel the feedforward control 402 corrects for predictable disturbances, such as the known stage trajectory and force required from stage mover 16, which will include (but is not limited to) the heat output from the coils.

As provided herein, the problem of precision temperature control of an outer surface of a motor is solved by augmenting error feedback with (i) feedforward of coil heat for disturbance compensation, (ii) predictive control for overcoming time lag, and (iii) an active bypass to maximize flow. In contrast, a control system that uses only error feedback for temperature control may be unable to achieve fine temperature control due to the fact that a significant heat energy is dissipated at each of the conductor units and rapid compensation of this disturbance would require a significantly large gains that may make the control system 422 unstable and oscillatory. To solve this problem, feedforward of the heat dissipation of various zones can be used to take compensatory action at an earlier time or in a more rapid manner than what is possible with a stable feedback controller, thereby providing finer temperature control.

Further, the feedforward control system 402 assists in solving a time lag (time delay “Td”) issue. More specifically, the valves in the inlet valve assembly 376 that operate the flow of the circulation fluid 342B into the zones 362A-362C are a finite distance away from the zones 362A-362C. If a valve opens (starting from a completely closed position to a finite flow) then the circulation fluid 342B that exits the valve will take a finite time to reach the respective zone 362A-362C. Thus, there is a time delay (Td) between when a valve opens and when the circulation fluid reaches the zone and starts cooling/heating. The time delay will depend on the fluid velocity, distance of fluid travel between the valves and the zones, and the diameter of the connecting lines. If the flow velocity is high (flow velocity can be made larger for a given flow rate by decreasing the cross-section), the time delay is lower, but the flow resistance (pressure drop) is larger. This time lag is detrimental to fine control of temperature since it limits the maximum stable gain.

This problem can be tackled by following ways. The time lag can be reduced by decreasing the distance between valves and the zones 362A-362C as well as by decreasing the cross section area of the tubes (to increase flow velocity for a given volumetric flow rate). However, but decreasing the area results in a penalty of increased flow resistance and higher pressure. Additionally, the feedforward control 402 can be calculated Td seconds ahead of time. The application of feedforward control 402 ahead of time (predictive control) is possible since the exact movements of the stage and the usage of the conductor units 40 is known ahead of time.

In certain embodiments, this time delay comes into play only when the previously flowing coolant is at a different temperature than the future coolant. For example, if the flowing coolant is at the medium temperature, and next, the hot temperature coolant is needed because the power to zone is reduced or turned off, the valves 376 need to open and close Td seconds before power to the conductor units 40 will be turned off. This hot coolant has to be turned on Td seconds before power to the coils is turned off. On the other hand, if coolant of the proper temperature was already flowing, and only a flow rate change is required, the valves 376 can adjust at the same time that the power dissipation of the conductor units 40 changes.

As provided herein, temperature control of the outer surface to within a narrow band is possible by making use of feedforward control 402 for disturbance compensation and actuating valves 376 and bypass valves 370C, 372C, 374C ahead of time to compensate for time lags. The feedforward control 402 reduces disturbances, and the feedback control 400 corrects errors in temperature.

One example of the sample logic for valve opening is as follows: (i) if −q<a<q medium temperature valve is opened (q is an empirical threshold for valve actuation that depends on feedforward and feedback gain and parameter “a” is defined above); (ii) if a>q (parameter “a” greater than q) then the hot valve is opened; (iii) if a<−q (parameter “a” less than negative q) then the cold valve is opened.

FIG. 4B is a simplified schematic of a portion of the feedforward control 402. In this embodiment, the feedforward control 402 utilizes a (computer generated) model temperature estimator 480 that is a simulated physical model of each zone 462. Using this model with the projected movements of the stage, the heat dissipation (both transient and steady state) can be calculated for each zone 462. By evaluating the heat that is dissipated in the zones 462, the control system 422, via the model temperature estimator 480 can control the temperature controller to individually control the temperature of each zone 462. Utilizing the simulated physical model, the control system 422 estimates the temperature and predicts the required coolant flow for each zone 462, and can selectively and individually control the flow of the circulation fluid to each of the zones 462 to achieve the predicted cooling requirements.

Further, with information from the feedback the feedback elements 264, the model temperature estimator can be regularly updated and improved so as to more accurately and effectively predict the required coolant flow rate for each zone 462.

FIG. 5 is a simplified graph that illustrates (i) a first profile 500 that illustrates power directed to one or more conductor units 40 in a first zone versus time; (ii) a second profile 502 that illustrates a temperature error (difference between desired and actual) for the first zone versus time without the use of feedforward control; and (iii) a third profile 504 that illustrates a temperature error (difference between desired and actual) for the first zone versus time with the use of feedforward control.

Comparing the second profile 502 to the third profile 504, there is less temperature error with feedforward control. More specifically, in the second profile 502, there is an overshoot error 506 because of the beginning of the power pulse directed to the coils in the first zone was not anticipated and the cold coolant was sent too late. Also, in the second profile 502, there is an undershoot error 508 because ending of the power pulse to the coils in the first zone was not anticipated and the hot coolant was sent too late.

In contrast, in the third profile 504, the overshoot 506 and the undershoot 508 have been significantly reduced using the feedforward control which can open or close valves in advance of any changes in the power supplied to the conductor units 40. As provided herein, the feedforward control can be used to reduce the influence of any predicted disturbance (e.g., changes in the applied heat) on the system.

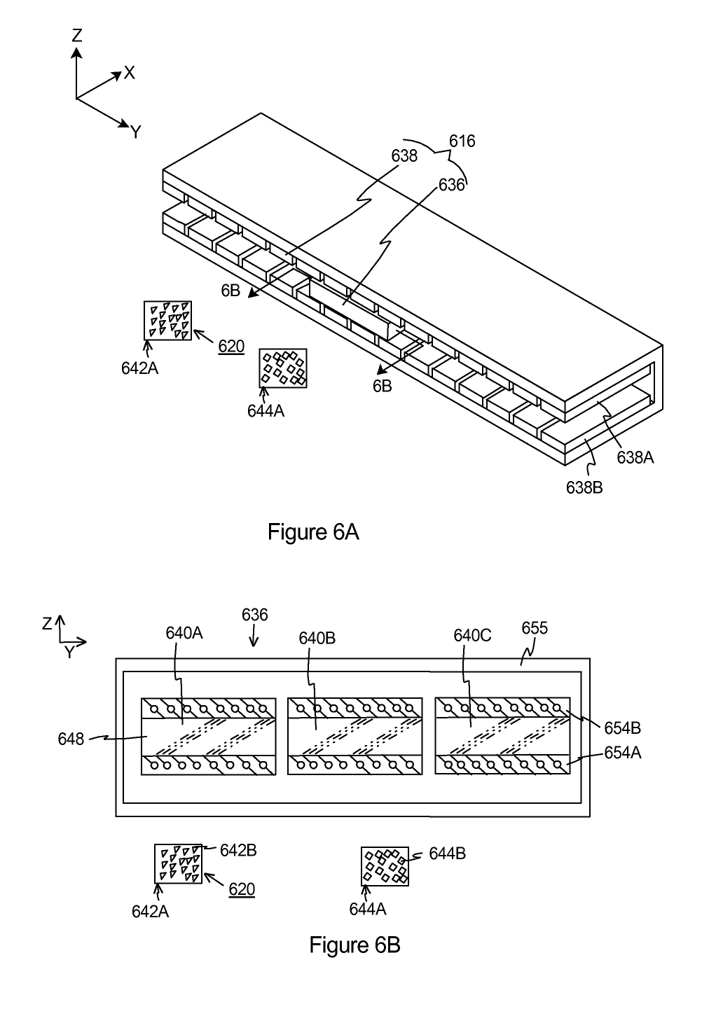

FIG. 6A illustrates another embodiment of a stage mover 616 and a temperature controller 620 including the fluid systems 642A, 644A. In this embodiment, the stage mover 616 is a linear mover (moves along the Y axis) that includes a conductor array 636 and a magnet array 638. In this embodiment, the magnet array 638 includes an upper magnet set 638A and a lower magnet set 638B and the conductor array 636 is positioned between the magnet sets 638A, 638B. Each magnet set 638A, 638B includes a plurality of rectangular shaped magnets that are aligned side-by-side. Alternatively, the magnet could be made of a single piece with varying direction of the magnetic field. The magnets in each magnet set 638A, 638B are orientated so that the poles alternate between the North pole and the South pole or in a Hallbach array.

FIG. 6B is a cut-away view of the conductor array 636 taken on line 6B-6B in FIG. 6A. In this embodiment, the conductor array 636 includes three conductor units 640A, 640B, 640C, with each including a conductor 648, an upper body heat exchanger 654A, and a lower body heat exchanger 654B. Further, a conductor housing 655 encircles the conductor units 640A, 640B, 640C and provides a passageway around the conductor units 640A, 640B, 640C. It should be noted that the conductor array 636 can be designed to include more than three or fewer than three coils and heat exchangers. Further, the heat exchangers can be individual or overlapping different coils.

With this design, the first temperature system 642A can individually control the flow of the first circulation fluid 642B to one or more of the heat exchangers 654A, 654B, and the second temperature system 644A can direct the second circulation fluid 644B into the passageway around the conductor units 640A, 640B, 640C.

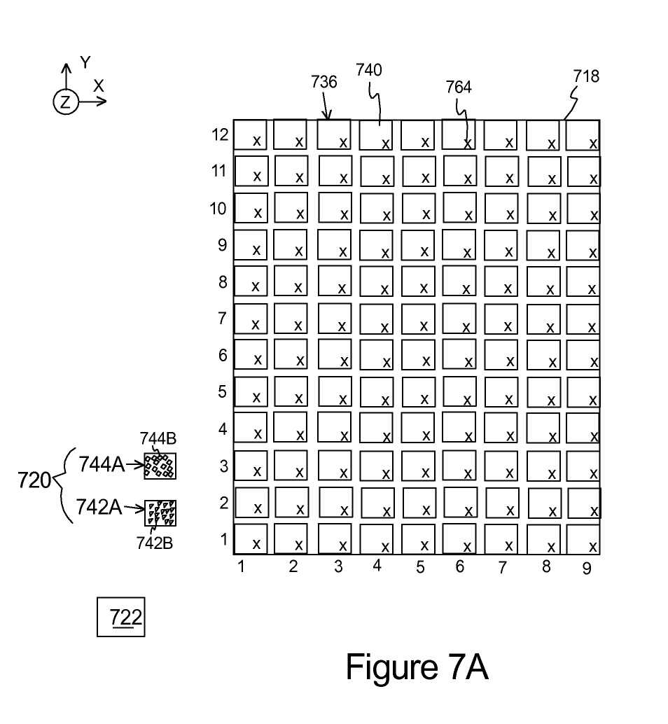

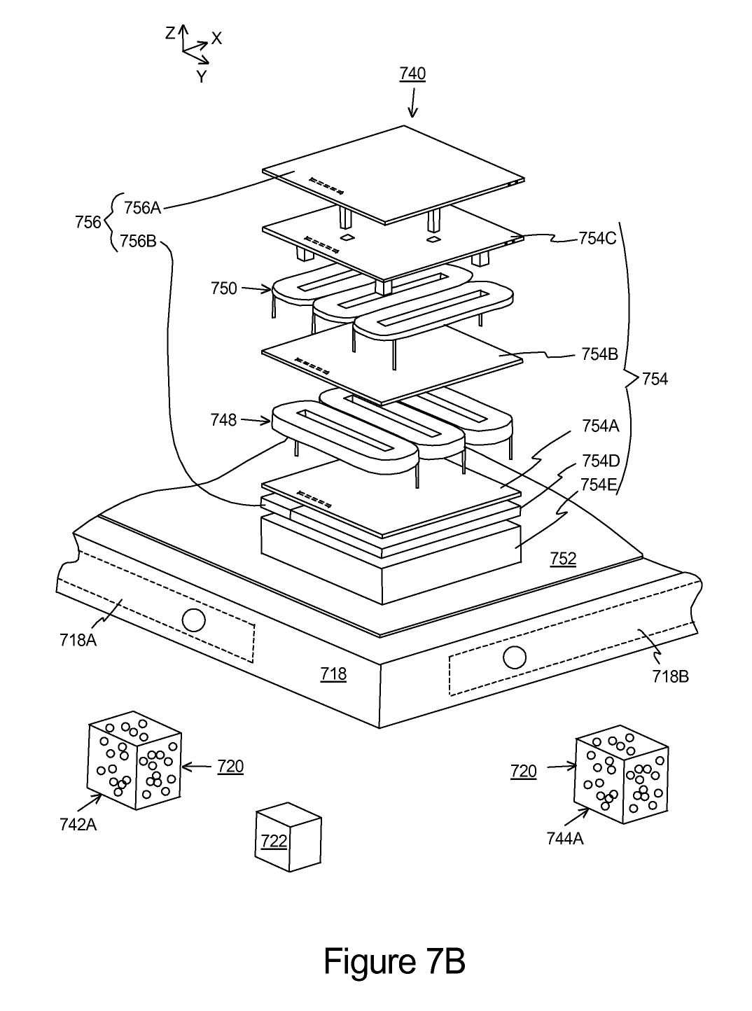

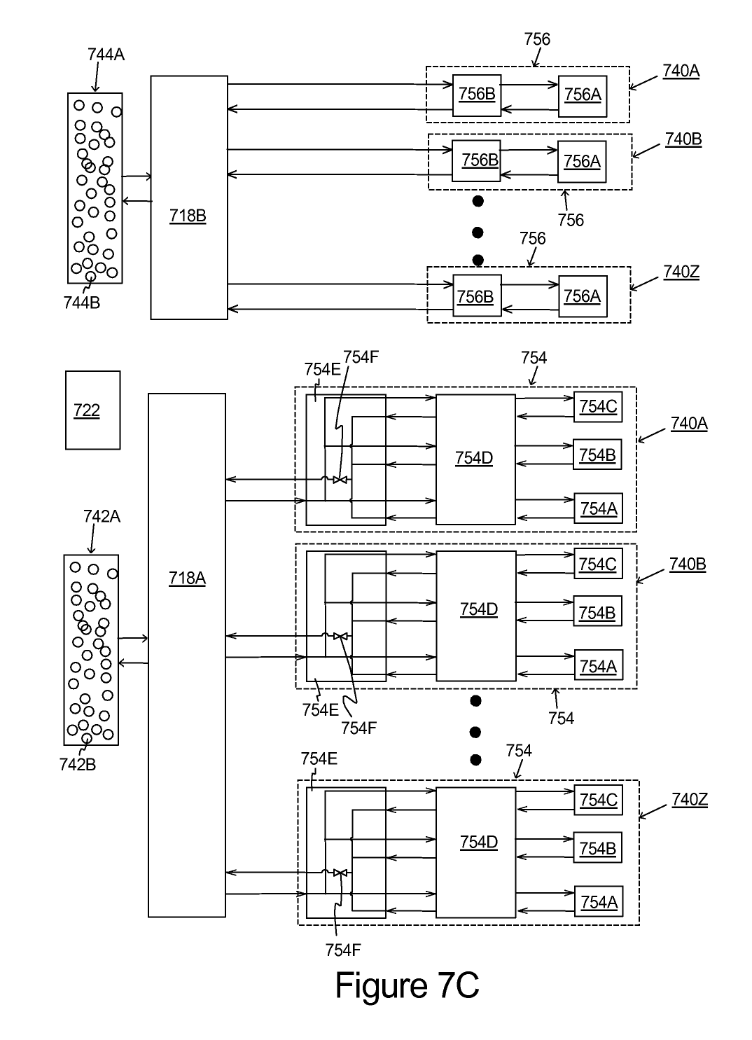

FIG. 7A is a simplified top view of yet another embodiment of the conductor array 736 including a plurality of conductor units 740, the base assembly 718, the temperature controller 720 including a first temperature system 742A and a second temperature system 744A, and the control system 722 that are somewhat similar to the corresponding components described above.

In FIG. 7A, the twelve rows are labeled (one to twelve moving bottom to top) and nine columns are labeled (one to nine moving left to right) of the conductor array 736 are labeled for reference. The position of each conductor unit 740 can be described in terms of its row and column number. As examples, (i) the lower left conductor unit 740 at row 1, column 1 can be labeled as the 1/1 conductor unit; and (ii) the upper left conductor unit 740 at row 12, column 1 can be labeled the 12/1 conductor unit.

As provided herein, the temperature controller 720 can be controlled by the control system 722 to selectively and individually control the flow rate and/or temperature of the first circulation fluid 742B and/or the second circulation fluid 744B to each conductor unit 740 depending upon the amount of heat generated by the respective conductor unit 740. Thus, during operation of the stage mover 716, if the 6/6 conductor unit generates more heat than the 12/1 conductor unit, the temperature controller 720 can selectively and individually adjust the temperature and/or flow rate of the first circulation fluid 742B and the second circulation fluid 744B accordingly. Alternatively, only the flow rate and temperature of the first circulation fluid 742B that is directed to each of the conductor units 740 is individually controlled.

With this design, the problem of using high volumetric flow rate of circulation fluids 742B, 744B (coolant) of a planar motor 716 is solved by controlling the fluid flow rate of one or both of the circulation fluids 742B, 744B to each conductor units 740 based on their power utilization. In this way, each conductor unit 740 is only supplied with the minimum necessary flow of the circulation fluids 742B, 744B.

Additionally, in this embodiment, each conductor unit 740 can include one or more feedback elements 764 (represented with an “x”) that provides feedback to the control system 722 for controlling the temperature controller 720.

FIG. 7B is an exploded perspective view of a single conductor unit 740 of a conductor array 736 of FIG. 7A, the temperature controller 720, the control system 722, a portion of the base 718, and a portion of the printed circuit board 752. In this embodiment, (i) the lower, first coil set 748 and the upper second coil set 750 of the conductor unit 740; (ii) the first body exchanger 754A, the second body exchanger 754B, and the third body exchanger 754C of the body exchanger assembly 754, and (iii) the surface exchanger 756A of the surface exchanger assembly 756 that are similar to the corresponding components described above and illustrated in FIGS. 2A and 2B.

However, in this embodiment, the base assembly 718 includes (i) a base body manifold 718A (illustrated with a box in phantom) that connects the first circulation system 742A in fluid communication with the body exchanger assembly 754 for each conductor unit 740, and (ii) a base surface manifold 718B (illustrated with a box in phantom) that connects the second circulation system 744A in fluid communication with the surface exchanger assembly 756 for each conductor unit 740.

Further, the body exchanger assembly 754 includes a unit body manifold 754D and a unit body flow control 754E that are in fluid communication with the base body manifold 718A; and (ii) the surface exchanger assembly 756 includes a unit surface manifold 756B that is in fluid communication with the base surface manifold 718B.

FIG. 7C is a simplified schematic of (i) the first temperature system 742A; (ii) the second temperature system 744A; (iii) the base surface manifold 718B; (iv) the base body manifold 718A; (v) the surface exchanger assembly 756 for a plurality of conductor units 740A, 740B, 740Z; (vi) the body exchanger assembly 754 for a plurality of conductor units 740A, 740B, 740Z; and (vii) the control system 722.

In this embodiment, (i) the first temperature system 742A independently directs the first circulation fluid 742B through the body exchanger assembly 754 of each conductor unit 740A, 740B, 740Z to remove the bulk of the heat; and (i) the second temperature system 744A directs the second circulation fluid 744B through the surface exchanger assembly 756 of each conductor unit 740A, 740B, 740Z to maintain the upper, outer surface of each conductor unit 740A, 740B, 740Z at the desired temperature.

In the embodiment illustrated in FIG. 7C, the first temperature system 742A is in fluid communication with the base body control manifold 718A. Subsequently, the base body control manifold 718A directs the first circulation fluid 742B to the body exchanger assembly 754 of each conductor unit 740A, 740B, 740Z. For each conductor unit 740A, 740B, 740Z, (i) the unit body flow control 754E is in fluid communication with the base body manifold 718A; (ii) the body flow control 754E is in fluid communication with the unit body manifold 754D; and (iii) the unit body manifold 754D is in fluid communication with and directs the first circulation fluid 742B to the three body exchangers 754A, 754B, 754C.

In one embodiment, the body flow control 754E of each conductor unit 740A, 740B, 740Z includes a valve assembly 754F that can be used to control the flow rate of the first circulation fluid 742B to the body exchangers 754A, 754B, 754C of each conductor unit 740A, 740B, 740Z. For example, the valve assembly 754F can be an electronic valve controlled by the control system 722. With this design, the control system 722 can independently and selectively adjust the valve assembly 754F of each conductor unit 740A, 740B, 740Z to selectively adjust and control the flow rate of the first circulation fluid 742B to the body exchangers 754A, 754B, 754C of each conductor unit 740A, 740B, 740Z. In alternative embodiments, the valve assembly 754F can be one or more fixed orifices that determine flow rates that correspond to the average heat dissipated in each conductor unit 740A, 740B, 740Z.

In FIG. 7C, each valve assembly 754F includes a single electronic valve that controls the flow rate of the first circulation fluid 742B returning from the unit body manifold 754D. Alternatively, the valve assembly 754F can be positioned as part of the inlet to the unit body manifold 754D. In one embodiment, the electronic valve is a pulse width modulated valve. In this embodiment, the flow rate is controlled using an on/off valve, with the on time and off time varied to adjust the flow rate. In another embodiment, the electronic valve is motorized metering valve.

Further, in FIG. 7C, the second circulation system 744A is in fluid communication with the base surface manifold 718B. Subsequently, the base surface manifold 718B directs the second circulation fluid 744B to the unit surface manifold 756B and the surface exchanger 756A of each conductor unit 740A, 740B, 740Z.

In summary, in FIG. 7C, (i) the flow rate of the first circulation fluid 742B is individually controlled and adjusted to each conductor unit 740A, 740B, 740Z (as needed based on the power consumption) to remove the bulk of the heat; and (ii) the flow rate of the second circulation fluid 744B is directed to each conductor unit 740A, 740B, 740Z at the same rate to maintain the surface temperature at the desired temperature.

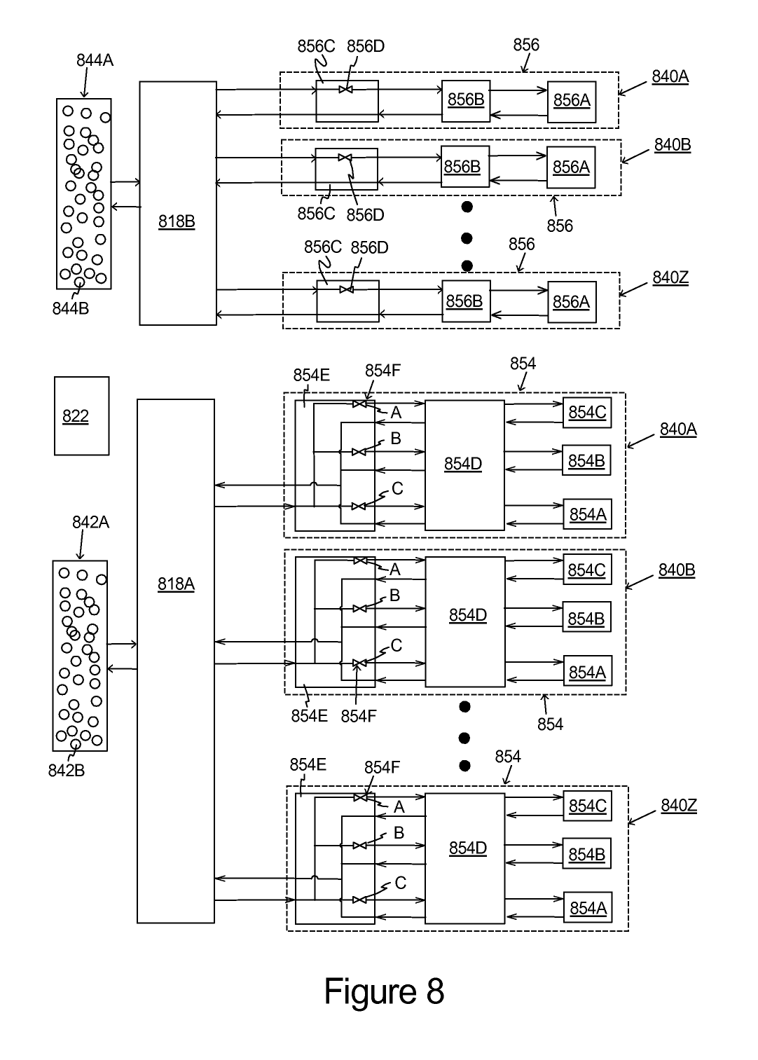

FIG. 8 is an alternative simplified schematic of (i) the first circulation system 842A; (ii) the second circulation system 844A; (iii) the base surface manifold 818B; (iv) the base body manifold 818A; (v) the surface exchanger assembly 856 for a plurality of conductor units 840A, 840B, 840Z; (vi) the body exchanger assembly 854 for a plurality of conductor units 840A, 840B, 840Z; and (vii) the control system 822 that are somewhat similar to the corresponding components described above and illustrated in FIG. 7C.

In FIG. 8, the first temperature system 842A is in fluid communication with the base body manifold 818A. Subsequently, the base body manifold 842A directs the first circulation fluid 842B to the body circulation assembly 854 of each conductor unit 840A, 840B, 840Z. For each conductor unit 840A, 840B, 840Z, (i) the body flow control 854E is in fluid communication with the base body manifold 818A; (ii) the body flow control 854E is in fluid communication with the unit body manifold 854D; and (iii) the unit body manifold 854D is in fluid communication with and directs the first circulation fluid 842B to the three body exchangers 854A, 854B, 854C.

Further, the body flow control 854E of each conductor unit 840A, 840B, 840Z includes a valve assembly 854F that can be used to independently control the flow rate of the first circulation fluid 842B to each of the body exchangers 854A, 854B, 854C of each conductor unit 840A, 840B, 840Z. For example, the valve assembly 854F can include three electronic valves A, B, C controlled by the control system 822. With this design, the control system 822 can independently and selectively adjust the valves A, B, C to selectively and independently adjust and control the flow rate of the first circulation fluid 8542B to each body exchanger 854A, 854B, 854C of each conductor unit 840A, 840B, 840Z based on the amount of heat generated, and which coil set (not shown in FIG. 8) is generating the heat. In FIG. 8, each valve A, B, C includes a single electronic valve that controls the flow rate of the first circulation fluid 842B at the inlet to the respective body exchangers 854A, 854B, 854C. Alternatively, the valves A, B, C can be positioned on the return flow.

Further, in FIG. 8, the second circulation system 844A is in fluid communication with the base surface manifold 818B. Subsequently, the base surface manifold 818B directs the second circulation fluid 844B to the surface exchanger assembly 856 of each conductor unit 840A, 840B, 840Z. For each conductor unit 840A, 840B, 840Z, a surface flow control 856C is in fluid communication with the base surface manifold 818B, and the surface exchanges 856A via the unit surface manifold 856B.

In this embodiment, the surface flow control 856C of each conductor unit 840A, 840B, 840Z includes a valve assembly 856D that can be used to individual control the flow rate of the second circulation fluid 844B to the surface exchange 856A of each conductor unit 840A, 840B, 840Z based on the flow rate required to maintain the proper surface temperature. For example, the valve assembly 856D can be an electronic valve controlled by the control system 822. The valve assembly 856D can be positioned at the inlet or the outlet of the unit surface manifold 856B. As non-exclusive examples, the valve assembly 856D can include a pulse width modulated valve or metering valve.

In summary, in FIG. 8, for each conductor unit 840A, 840B, 840Z, (i) the flow rate of the first circulation fluid 842B is individually controlled to each body exchanger 854A, 854B, 854C of each to remove the bulk of the heat; and (ii) the flow rate of the second circulation fluid 844B is individually controlled to each surface exchanger 856A to maintain the outer surface at the desired temperature.

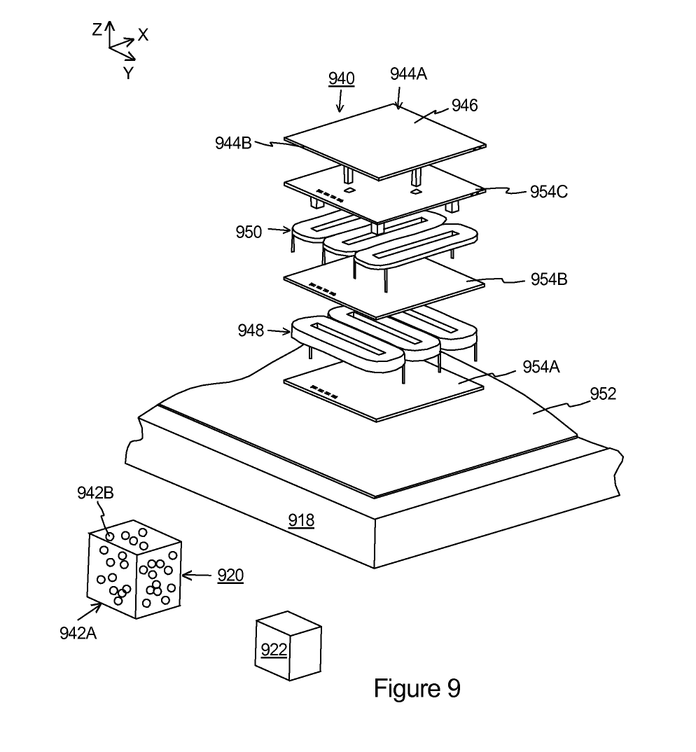

It should be noted that other embodiments of the temperature controller are possible. FIG. 9 is an exploded perspective view of yet another embodiment of single conductor unit 940, the temperature controller 920, the control system 922, a portion of the base 918, and a portion of the printed circuit board 952. In this embodiment, (i) the lower, first coil set 948 and the upper second coil set 950 of the conductor unit 940; (ii) the first body exchanger 954A, the second body exchanger 954B, and the third body exchanger 954C, and (iii) the first temperature system 942A are similar to the corresponding components described above.

In this embodiment, the first circulation system 942A again directs the circulation fluid 942B through the body exchangers 954A, 954B, 954C to remove the bulk of the heat from the conductor unit 940. Further, the flow rate and/or temperature of the first circulation fluid 942B (i) can be selectively and individually controlled according to the heat generated by each conductor unit 940; (ii) can be selectively and individually controlled to various portions of each conductor unit 940; (iii) can be selectively and individually controlled to various groups of the conductor units 940; or (iv) can be controlled to be the same for all of the conductor units 940.

However, in this embodiment, the second temperature system 944A is different. More specifically, in this embodiment, the second temperature system 944A includes an exchanger assembly 944B that includes a phase change material to maintain the upper, outer surface 946 of each conductor unit 940 at the desired temperature. This can inhibit the transfer of heat from the conductor units 940 to the surrounding environment.

In certain embodiments, the phase change material can be engineered to melt/freeze or to boil/condense at the required temperature. With this design, the surface temperature can be maintained without directing a coolant through the exchanger assembly 944B. Thus, a very large flow of coolant is not necessary to maintain constant temperature of the surface 946.

With this design, the problem of temperature control of the countermass surface temperature using fluid flow along with active control system is solved by a stationary phase change material at the surface of the countermass that changes phase at the nominal surface temperature without the need for fluid flow or active temperature control.

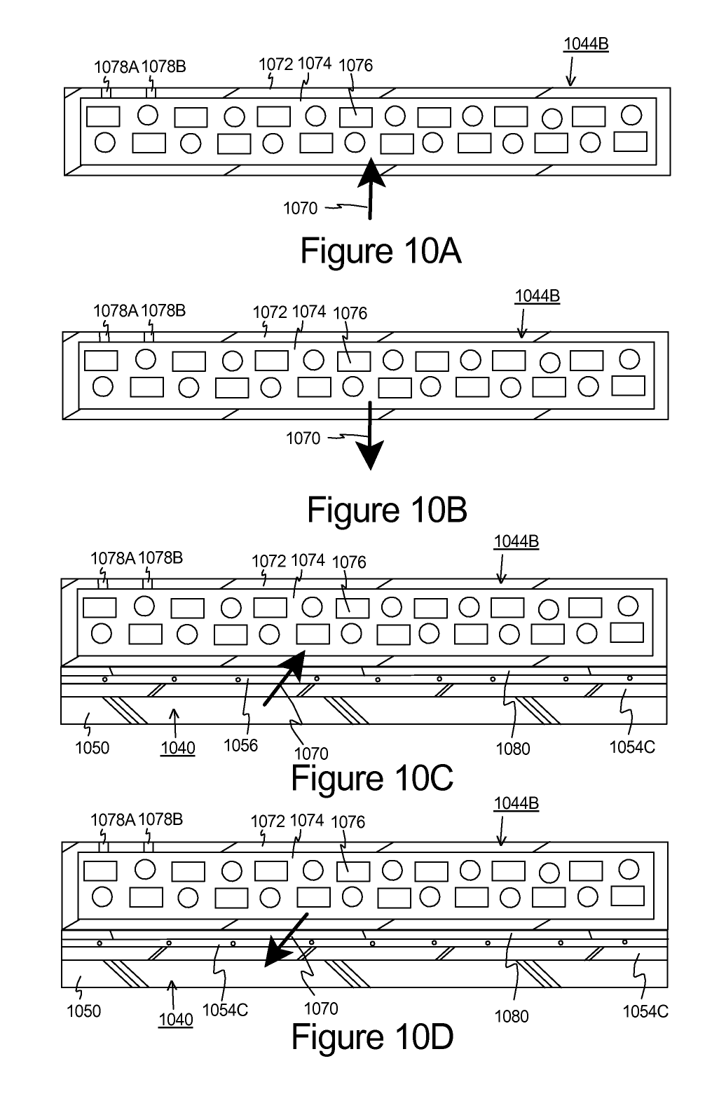

FIG. 10A is a simplified side, cut-away view of an exchanger assembly 1044B having features of the present invention with heat 1070 (illustrated as an arrow) flowing into the exchanger assembly 1044B. Further, FIG. 10B is a simplified side, cut-away view of the exchanger assembly 1044B with heat 1070 (illustrated as an arrow) flowing out of the exchanger assembly 1044B. This exchanger assembly 1044B can be used to maintain the surface temperature of one conductor units 940 illustrated in FIG. 9, or another type of conductor or object at a predetermined desired temperature. Still alternatively, a single exchanger assembly 1044B can be positioned on top of multiple conductor units to maintain the surface temperature of multiple conductor units. Still alternatively, a single exchanger assembly 1044B can be positioned adjacent to an entire or a portion of a conductor array.

In this embodiment, the exchanger assembly 1044B includes a housing assembly 1072 that defines a sealed housing chamber 1074, and a substantially stationary (non-circulating) phase change material 1076 positioned in the sealed housing chamber 1074. The housing 1072 can be made from a non-electrically conductive, non-magnetic material, such as titanium, or non-electrically conductive plastic or ceramic.

In this example, the phase change material 1076 is represented with (i) rectangles that illustrate the “colder” phase (e.g., solid or liquid of the phase change material 1076, and (ii) circles that illustrate the “hotter” phase (liquid or gaseous, respectively) of the phase change material 1076. In the examples illustrated in the Figures provided herein, the phase change material 1076 is illustrated as being approximately one half in the colder state and approximately one half in the hotter state. However, the actual physical phase of the phase change material 1076 will depend on how much heat is being added or removed from the phase change material 1076. Further, in this embodiment, the phase change material 1076 is sealed within and does not circulate in and out of the sealed housing chamber 1074. With this design, the layer of phase change material 1076 (PCM) (for example an inert, organic-microencapsulated PCM) could be used on the topmost surface of the conductor array. The phase change material 1076 can change between liquid and solid or between liquid and vapor.

Additionally, in certain embodiments, the exchanger assembly 1044B can include one or more feedback elements 1078A, 1078B (two are illustrated herein) which can be used to determine the present phase of the phase change material 1076. With this design, feedback from the feedback elements 1078A, 1078B can be directed to the control system (not shown) which can control the flow and/or temperature of the first circulation fluid (not shown) to actively control the phase of the phase change material 1076. In certain embodiments, the control system maintains the phase change material 1076 at approximately a 50/50 solid to liquid (or liquid to vapor) ratio so that the phase change material 1076 is ready to absorb or liberate heat while still maintaining the desired surface temperature. As non-exclusive examples, one of the feedback elements 1078A can be a temperature sensor, and the other feedback element 1078B can be a pressure sensor or an optical sensor that measures transparency or opacity of phase change material.

Importantly, in this embodiment, heat can be absorbed or liberated from the exchanger assembly 1044B while still maintaining approximately the same temperature of the exchanger assembly 1044B. FIG. 10A illustrates heat 1070 flowing into the phase change material 1076. The heat 1070 flowing into the phase change material 1076 will cause the phase change from solid to liquid (or liquid to vapor). In contrast, FIG. 10B illustrates heat 1070 flowing out of the phase change material 1076. The heat 1070 flowing out of the phase change material 1076 will cause the phase change from liquid to solid (or vapor to liquid).

FIG. 10C is a simplified side cut-away view of the exchanger assembly 1044B, and a portion of a conductor unit 1040 including an insulator 1080, the surface exchanger 1056, the upper body exchanger 1054C, and the upper coil set 1050 (illustrated with a box) with heat 1070 flowing from the conductor unit 1040 into the exchanger assembly 1044B. Somewhat similarly, FIG. 10D is a simplified side cut-away view of the exchanger assembly 1044B, and a portion of a conductor unit 1040 including the insulator 1080, the surface exchanger 1056, the upper body exchanger 1054C, and the upper coil set 1050 (illustrated with a box) with heat 1070 flowing into the conductor unit 1040 from the exchanger assembly 1044B.

In one embodiment, the predetermined temperature is twenty-three degrees Celsius. In FIG. 10C, the phase change material 1076 absorbs heat 1070 and changes from solid to liquid while remaining a constant temperature of twenty-three degrees Celsius. Alternatively, in FIG. 10D, the phase change material 1076 liberates heat 1070 and changes from liquid to solid while remaining a constant temperature of twenty-three degrees Celsius.

The design of the phase change material 1076 can be varied according to the desired predetermined temperature. As provided herein, the phase change material 1076 can be engineered to have a melting point at the specific, predetermined desired temperature. As a non-exclusive example, the phase change material 1076 can be designed to have a phase change temperature (solid to liquid) at 23 C. Non-exclusive examples of the phase change material 1076 include hydrated salts or organic materials which are able to change phase at around 20C. The size and shape of the exchanger assembly 1044B and the phase change material 1076 can be varied to suit the design requirements of the system.

One advantage of the embodiment shown in FIGS. 10C, 10D is that the nominal temperature can be maintained even in the presence of variations over time in the heat flow to/from the conductor unit 1040 without the use of a flow of fluid or active control system. The temperature is passively maintained constant by selecting an appropriately engineered phase change material that changes phase at the required temperature. The phase change material will take care of any stray heat.

It should be noted that the heat dissipated by the conductor units 1040 still needs to be extracted out of the system by the circulation fluid. However, in this example, the top surface of the housing 1072 can be maintained at a substantially constant and uniform temperature.

The present invention can be used in all lithography systems for maintaining constant temperature without the need for flow or active control system which reduces cost and more allows for more compact design.

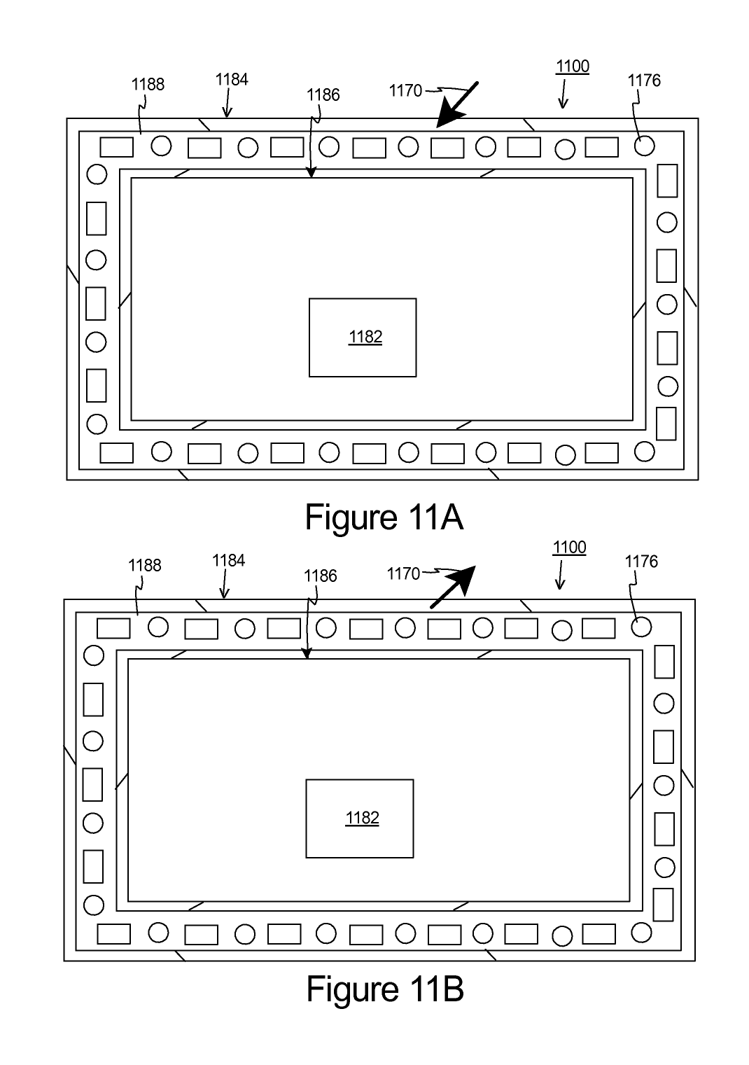

FIG. 11A is a simplified cut-away view of an assembly 1100 having features of the present invention with heat 1170 (illustrated as an arrow) flowing into the assembly 1100, and FIG. 11B is a simplified cut-away view of the assembly 1100 with heat 1170 flowing from the assembly 1100. As provided herein, certain components/equipment 1182 are temperature sensitive and need to be operated at a predetermined temperature. In this embodiment, the assembly 1100 includes a housing 1184 that defines a first enclosure 1186 and a sealed second enclosure 1188. Further, the first enclosure 1186 is sized and shaped to receive the component 1182 and the second enclosure 1188 encircles the first enclosure 1186. Further, the second enclosure 1188 is filled with a non-circulated phase change material 1176.

With this design the present invention can be used to control the temperature of temperature sensitive equipment 1182. For example, for precision equipment 1182 that needs a constant temperature (e.g. 23C) but is also exposed sometimes to the heat (e.g. sun) or sometimes to cold then the phase change material 1176 could be used to maintain same temperature. In that case, the enclosure of the equipment 1182 can be made of phase change material 1176 (with appropriate phase change temperature). With this design, the phase change material 1176 surrounds the area to be kept at constant temperature. The phase change material 1176 liberates heat and freezes but temperature is constant at 23C. Further, the phase change material 1176 takes up heat and melts but temperature is constant at 23C.

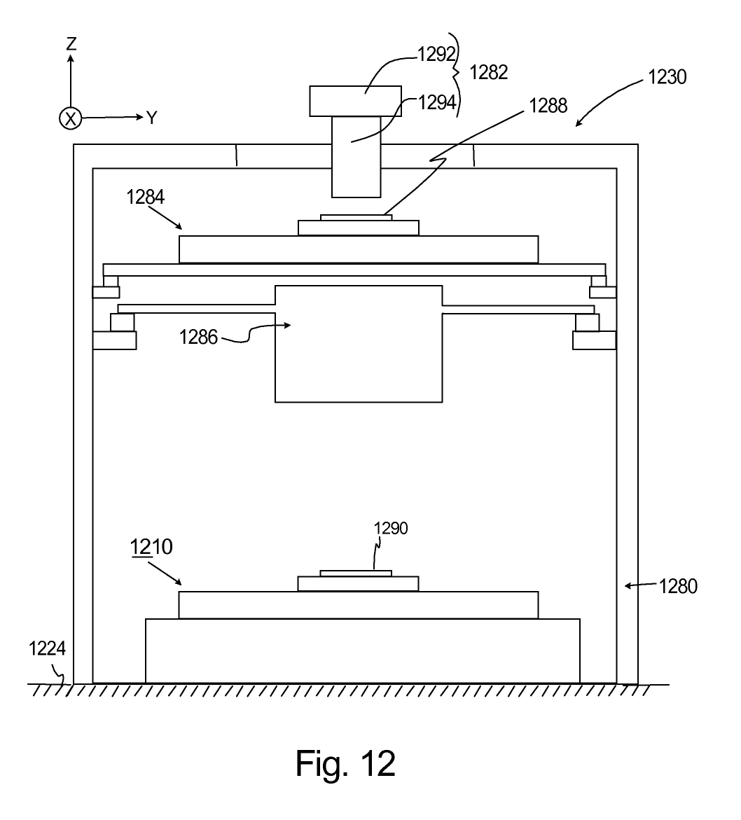

FIG. 12 is a schematic view illustrating an exposure apparatus 1230 useful with the present invention. The exposure apparatus 1230 includes the apparatus frame 1280, an illumination system 1282 (irradiation apparatus), a reticle stage assembly 1284, an optical assembly 1286 (lens assembly), and a wafer stage assembly 1210. The stage assemblies provided herein can be used as the wafer stage assembly 1210. Alternately, with the disclosure provided herein, the stage assemblies provided herein can be modified for use as the reticle stage assembly 1284.

The exposure apparatus 1230 is particularly useful as a lithographic device that transfers a pattern (not shown) of an integrated circuit from the reticle 1288 onto the semiconductor wafer 1290. The exposure apparatus 1230 mounts to the mounting base 1224, e.g., the ground, a base, or floor or some other supporting structure.

The illumination system 1282 includes an illumination source 1292 and an illumination optical assembly 1294. The illumination source 1292 emits a beam (irradiation) of light energy. The illumination optical assembly 1294 guides the beam of light energy from the illumination source 1292 to the optical assembly 1286. The beam illuminates selectively different portions of the reticle 1288 and exposes the semiconductor wafer 1290. In FIG. 12, the illumination source 1292 is illustrated as being supported above the reticle stage assembly 1284. Alternatively, the illumination source 1292 can be secured to one of the sides of the apparatus frame 1280 and the energy beam from the illumination source 1292 is directed to above the reticle stage assembly 1284 with the illumination optical assembly 1294.

The optical assembly 1286 projects and/or focuses the light passing through the reticle to the wafer. Depending upon the design of the exposure apparatus 1230, the optical assembly 1286 can magnify or reduce the image illuminated on the reticle.

The reticle stage assembly 1284 holds and positions the reticle 1288 relative to the optical assembly 1286 and the wafer 1290. Similarly, the wafer stage assembly 1210 holds and positions the wafer 1290 with respect to the projected image of the illuminated portions of the reticle 1288.

There are a number of different types of lithographic devices. For example, the exposure apparatus 1230 can be used as scanning type photolithography system that exposes the pattern from the reticle 1288 onto the wafer 1290 with the reticle 1288 and the wafer 1290 moving synchronously. Alternatively, the exposure apparatus 1230 can be a step-and-repeat type photolithography system that exposes the reticle 1288 while the reticle 1288 and the wafer 1290 are stationary.

However, the use of the exposure apparatus 1230 and the stage assemblies provided herein are not limited to a photolithography system for semiconductor manufacturing. The exposure apparatus 1230, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, elevators, machine tools, metal cutting machines, inspection machines and disk drives.

As described above, a photolithography system according to the above described embodiments can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

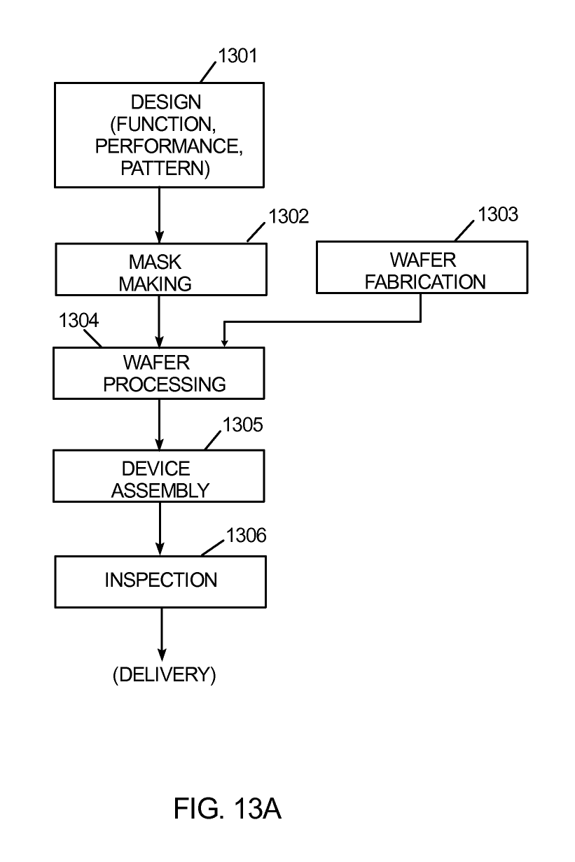

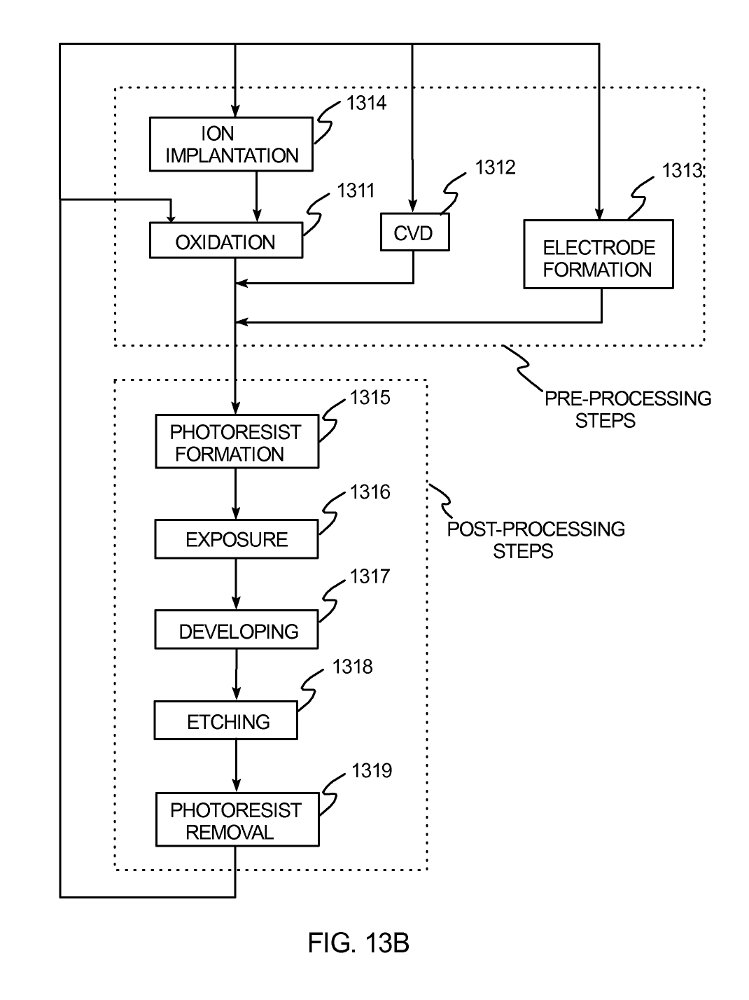

Further, semiconductor devices can be fabricated using the above described systems, by the process shown generally in FIG. 13A. In step 1301 the device's function and performance characteristics are designed. Next, in step 1302, a mask (reticle) having a pattern is designed according to the previous designing step, and in a parallel step 1303 a wafer is made from a silicon material. The mask pattern designed in step 1302 is exposed onto the wafer from step 1303 in step 1304 by a photolithography system described hereinabove in accordance with the present invention. In step 1305 the semiconductor device is assembled (including the dicing process, bonding process and packaging process), finally, the device is then inspected in step 1306.

FIG. 13B illustrates a detailed flowchart example of the above-mentioned step 1304 in the case of fabricating semiconductor devices. In FIG. 13B, in step 1311 (oxidation step), the wafer surface is oxidized. In step 1312 (CVD step), an insulation film is formed on the wafer surface. In step 1313 (electrode formation step), electrodes are formed on the wafer by vapor deposition. In step 1314 (ion implantation step), ions are implanted in the wafer. The above mentioned steps 1311-1314 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 1315 (photoresist formation step), photoresist is applied to a wafer. Next, in step 1316 (exposure step), the above-mentioned exposure device is used to transfer the circuit pattern of a mask (reticle) to a wafer. Then in step 1317 (developing step), the exposed wafer is developed, and in step 1318 (etching step), parts other than residual photoresist (exposed material surface) are removed by etching. In step 1319 (photoresist removal step), unnecessary photoresist remaining after etching is removed.

Multiple circuit patterns are formed by repetition of these preprocessing and post-processing steps.

While the particular stage assembly as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A stage assembly that moves a device, the stage assembly comprising:
a stage that retains the device;
a base assembly;
a stage mover that moves the stage, the stage mover including a magnet array that is secured to one of the stage and the base assembly, and a conductor array that is secured to the other of the stage and the base assembly, the conductor array including a first zone having a first body heat exchanger and a second zone having a second body heat exchanger, wherein current directed to conductor array creates a force that can be used to move one of the arrays relative to the other array;
a temperature controller that includes (i) an inlet valve assembly that is in fluid communication with the first body heat exchanger, and the second body heat exchanger, and (ii) a first temperature system that is in fluid communication with the inlet valve assembly, the first temperature system directing a body circulation fluid at a first temperature, and at a second temperature to the inlet valve assembly, the first temperature being different than the second temperature; and
a control system that controls the inlet valve assembly to selectively control (i) the flow rate of the body circulation fluid at the first temperature, and the flow rate of the body circulation fluid at the second temperature that is directed to the first body heat exchanger, and (ii) the flow rate of the body circulation fluid at the first temperature, and the flow rate of the body circulation fluid at the second temperature that is directed to the second body heat exchanger.

2. The stage assembly of claim 1 further comprising a stage base, and wherein the base assembly includes a countermass that is supported by the stage base, wherein the countermass moves relative to the stage base when the force is created to move one of the arrays relative to the other array.

3. The stage assembly of claim 1 wherein the first temperature system also directs the body circulation fluid at a third temperature to the inlet valve assembly; wherein the third temperature is different than the first and second temperatures; and wherein the control system controls the inlet valve assembly to selectively control (i) the flow rate of the body circulation fluid at the first temperature, the flow rate of the body circulation fluid at the second temperature, and the flow rate of the body circulation fluid at the third temperature that is directed to the first body heat exchanger, and (ii) the flow rate of the body circulation fluid at the first temperature, the flow rate of the body circulation fluid at the second temperature, and the flow rate of the body circulation fluid at the third temperature that is directed to the second body heat exchanger.

4. The stage assembly of claim 1 wherein the conductor array includes a third zone having a third body heat exchanger; wherein the inlet valve assembly is in fluid communication with the third body heat exchanger; and wherein the control system controls the inlet valve assembly to selectively control the flow rate of the circulation fluid at the first temperature, the flow rate of the circulation fluid at the second temperature, and the flow rate of the circulation fluid at the third temperature that is directed to the third body heat exchanger.

5. The stage assembly of claim 1 wherein the temperature controller includes a first temperature unit that supplies the circulation fluid at the first temperature, a second temperature unit that supplies the circulation fluid at the second temperature, and an outlet valve assembly that selectively routes the circulation fluid exiting the body heat exchangers to each of the temperature units.

6. The stage assembly of claim 5 further comprising a first bypass valve that is controlled to selectively direct the first circulation fluid to flow from an outlet of the first temperature unit to an inlet of the first temperature unit to maintain a predetermined minimum flow in the first temperature unit.

7. The stage assembly of claim 1 wherein the conductor array includes a surface heat exchanger, and wherein the temperature controller includes a second temperature system that directs a second circulation fluid through the surface heat exchanger.

8. The stage assembly of claim 1 wherein the conductor array includes a housing assembly that retains a phase change material in an enclosed chamber near the first body heat exchanger.

9. The stage assembly of claim 1 wherein the stage mover is a planar motor and the conductor array includes a plurality of conductor units that are arranged in a rectangular shaped grid.

10. The stage assembly of claim 1 wherein the control system utilizes feedforward control based on the expected heat dissipation of each zone in the control of the inlet valve assembly.

11. An exposure apparatus for transferring an image from a reticle to a device, the exposure apparatus comprising: an illumination system that directs an illumination beam at the reticle, and stage assembly of claim 1 moving one of the reticle and the device.

12. A stage assembly that moves a device, the stage assembly comprising:
a stage that retains the device;
a base assembly;
a stage mover that moves the stage along a first axis, the stage mover including a magnet array that is secured to one of the stage and the base assembly, and a conductor array that is secured to the other of the stage and the base assembly, the conductor array including a first zone and a second zone, wherein current directed to the conductor array generates a force on the stage;
a temperature controller that selectively directs a first circulation fluid to the first zone and the second zone; and
a control system that controls the temperature controller to independently control at least one of the flow rate and temperature of the circulation fluid to the first zone and to the second zone, wherein the control system utilizes feedforward control based on the expected heat load for each zone.

13. The stage assembly of claim 12 further comprising a feedback element assembly that provides feedback regarding the first zone and the second zone, and wherein the control system uses feedback control in addition to feedforward control.

14. The stage assembly of claim 12 further comprising a stage base, and wherein the base assembly includes a countermass that is supported by the stage base, wherein the countermass moves relative to the stage base when the force is created to move one of the arrays relative to the other array.

15. The stage assembly of claim 12 wherein the conductor array includes a surface heat exchanger, and wherein the temperature controller includes a second temperature system that directs a second circulation fluid through the surface heat exchanger.

16. A stage assembly that moves a device, the stage assembly comprising:
a stage that retains the device;
a base assembly;
a stage mover that moves the stage, the stage mover including a magnet array that is secured to one of the stage and the base assembly, and a conductor array that is secured to the other of the stage and the base assembly, wherein current directed to the conductor array generates a force on the stage; and
a temperature controller that controls the temperature of the conductor array, the temperature controller including a phase change material and a housing assembly that retains the phase change material in an enclosed chamber near the conductor array.

17. The stage assembly of claim 16 wherein the conductor array includes a first zone having a first body heat exchanger and a second zone having a second body heat exchanger, wherein the temperature controller independently directs a first circulation fluid to the first body heat exchanger and the second body heat exchanger.

18. The stage assembly of claim 16 wherein the stage mover is a planar motor and the conductor array includes a plurality of conductor units that are arranged in a rectangular shaped grid.

19. The stage assembly of claim 16 wherein at least a portion of the phase change material changes between a liquid phase and a solid phase as the heat dissipation of the conductor array changes with time.

20. The stage assembly of claim 16 wherein at least a portion of the phase change material changes between a gaseous phase and a liquid phase as the heat dissipation of the conductor array changes with time.

21. The stage assembly of claim 16 wherein at least a portion of the phase change material changes between a gaseous phase and a liquid phase, and the gaseous and liquid phase change material moves within the enclosed chamber to transfer heat from at least one warmer location to at least one colder location.

22. A stage assembly that moves a device, the stage assembly comprising:
a stage that retains the device;
a base assembly;
a planar mover that moves the stage, the stage mover including a magnet array that is secured to one of the stage and the base assembly, and a conductor array that is secured to the other of the stage and the reaction assembly, the conductor array including a plurality of conductor units that are arranged in a two dimensional array, wherein current directed to one or more of conductor units generates a force on the stage; and
a temperature controller that independently adjusts the temperature of each conductor unit of the conductor array.

23. The stage assembly of claim 22 wherein the temperature controller independently controls at least one of a temperature and a flow rate of a circulation fluid supplied to each conductor unit.

24. The stage assembly of claim 23 wherein the temperatures or flow rates are actively controlled using a valve assembly.

25. The stage assembly of claim 23 wherein the flow rate to each conductor unit is individually controlled with a flow restrictor.
